(19) United States
(12) Patent Application Publication
(10) Pub. No.: US 2026/0348452 A1
(43) Pub. Date: Nov. 5, 2026

(54) DRIVE TRANSMISSION DEVICE, SHEET CONVEYOR, AND IMAGE FORMING APPARATUS

(71) Applicant: Kenji TOMITA, Tokyo (JP)

(72) Inventor: Kenji TOMITA, Tokyo (JP)

(73) Assignee: ETRIA CO., LTD., Yokohama-shi (JP)

(21) Appl. No.: 19/633,291

(22) Filed: Mar. 30, 2026

(30) Foreign Application Priority Data
Apr. 30, 2025 (JP) 2025-075731

(51) Int. Cl. F16H 3/00; G03G 15/00

(52) U.S. Cl. CPC F16H 3/006; G03G 15/6529; G03G 2215/00679

(57) ABSTRACT

A drive transmission device includes a transmission to transmit a driving force from a drive source to a rotator via a transmission path. The transmission path includes a first drive transmission path and a second drive transmission path. The first drive transmission path includes a single-rotation clutch to rotate a rotator at a first speed. The second drive transmission path rotates the rotator at a second speed lower than the first speed. The single-rotation clutch of the first drive transmission path selectively switches the transmission path between the first drive transmission path and the second drive transmission path.

### CROSS-REFERENCE TO RELATED APPLICATIONS

This patent application is based on and claims priority pursuant to 35 U.S.C. § 119(a) to Japanese Patent Application No. 2025-075731, filed on Apr. 30, 2025, in the Japan Patent Office, the entire disclosure of which is hereby incorporated by reference herein.

### BACKGROUND

### Technical Field

The present disclosure relates to a drive transmission device, a sheet conveyor, and an image forming apparatus.

### Related Art

Drive transmission devices in the art are known that selectively switch a drive transmission path between a first drive transmission path for rotating an output target rotary body at a first speed and a second drive transmission path for rotating the output target rotary body at a second speed lower than the first speed.

For example, a drive apparatus in the art includes a first drive transmission path for rotationally driving a sheet conveyance roller as an output target rotary body at a speed (acceleration state) faster than a process speed (peripheral speed of a photoconductor), and a second drive transmission path for rotationally driving the sheet conveyance roller at a process speed (constant speed state). The first drive transmission path includes an acceleration gear and an acceleration output gear meshing with the acceleration gear. The second drive transmission path includes a constant-speed gear and a constant-speed output gear meshing with the constant-speed gear. The acceleration gear and the constant-speed gear are attached to a transmission shaft as a rotation shaft that rotates when a driving force is transmitted from a drive source. The acceleration output gear and the constant-speed output gear are attached to the shaft of the sheet conveyance roller. The acceleration gear is attached to the transmission shaft via an electromagnetic clutch as a clutch mechanism, and the constant-speed gear is attached to the transmission shaft via a one-way clutch.

When the electromagnetic clutch is off, the acceleration gear idles with respect to the transmission shaft, and the driving force is transmitted to the sheet conveyance roller via the second drive transmission path. When the electromagnetic clutch is on, the driving force is transmitted to the sheet conveyance roller via the first drive transmission path. At this time, the driving force is transmitted from the constant-speed output gear to the constant-speed gear attached to the transmission shaft via the one-way clutch, the constant-speed gear rotates faster than the transmission shaft and idles with respect to the transmission shaft, and the drive transmission of the second drive transmission path is interrupted. Thus, the drive transmission path is selectively switched between the first drive transmission path and the second drive transmission path.

However, when the driving force is transmitted to the output target rotary body through the first drive transmission path, it is necessary to continuously flow the current to the electromagnetic clutch, and there is a problem in energy saving.

### SUMMARY

Embodiments of the present disclosure described herein provide a novel drive transmission device including a transmission to transmit a driving force from a drive source to a rotator via a transmission path. The transmission path includes a first drive transmission path and a second drive transmission path. The first drive transmission path includes a single-rotation clutch to rotate a rotator at a first speed. The second drive transmission path rotates the rotator at a second speed lower than the first speed. The single-rotation clutch of the first drive transmission path selectively switches the transmission path between the first drive transmission path and the second drive transmission path.

Further, embodiments of the present disclosure described herein provide a sheet conveyor including a conveyance roller, a drive source, and the above-described drive transmission device. The conveyance roller conveys a sheet. The drive source drives the conveyance roller. The drive transmission device transmits a driving force of the drive source to the conveyance roller, and changes a rotation speed of the conveyance roller according to a position of the sheet being conveyed.

Further, embodiments of the present disclosure described herein provide an image forming apparatus including the above-described sheet conveyor to convey the sheet to form an image on the sheet.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of an image forming apparatus 1 according to an embodiment of the present disclosure;

FIGS. 2A and 2B are perspective views of a schematic configuration of a sheet feeding drive device that drives a sheet feed roller;

FIG. 3 is an exploded perspective view of the sheet feeding drive device as viewed from one side in an axial direction;

FIG. 4 is an exploded perspective view of the sheet feeding drive device as viewed from the other side in the axial direction;

FIG. 5 is a cross-sectional view of a schematic configuration of a drive transmission unit;

FIG. 6 is a diagram illustrating a configuration of a single rotation clutch mechanism;

FIGS. 7A, 7B and 7C are diagrams illustrating a common planet carrier;

FIG. 8 is a diagram illustrating conveyance of a sheet to a transfer nip;

FIG. 9 is a diagram illustrating a sequence of sheet feeding;

FIGS. 10A and 10B are perspective views of schematic configurations of the sheet ejection drive device;

FIG. 11 is a diagram illustrating switchback conveying of a sheet S when a duplex print mode is set;

FIG. 12 is a diagram illustrating a sequence of switchback conveying;

FIG. 13 is an exploded perspective view of an example of a drive device using a roller type one-way clutch mechanism as high-speed side and low-speed side one-way clutch mechanisms;

FIG. 14A is a graph of a change in the rotation speed of the sheet feed roller in a case where a planetary gear type one-way clutch mechanism is provided in each drive transmission path;

FIG. 14B is a graph of a change in the rotation speed of the sheet feed roller in a case where a drive transmission path roller type one-way clutch mechanism is provided in each drive transmission path;

FIG. 15 is a perspective view of a drive device of Modification 1 as viewed from one side in the axial direction;

FIG. 16 is a perspective view of a drive device of Modification 1 as viewed from the other side in the axial direction;

FIG. 17 is an exploded perspective view of a drive device according to a modification as viewed from one side in the axial direction;

FIG. 18 is an exploded perspective view of the drive device of Modification 1 as viewed from the other side in the axial direction;

FIG. 19A is a cross-sectional view of a joint member in a state where the joint member is drivingly coupled to a low-speed gear;

FIG. 19B is a cross-sectional view of a joint member in a state where the joint member is drivingly coupled to a high-speed gear; and

FIG. 20 is a schematic view of an example of each protrusion of a low-speed side input engagement portion and each protrusion of a low-speed side output engagement portion.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Like reference signs are assigned to identical or equivalent components and a description of those components may be simplified or omitted.

The following describes as an embodiment of an image forming apparatus to which the present disclosure is applied, an image forming apparatus that forms an image by an electrophotographic method.

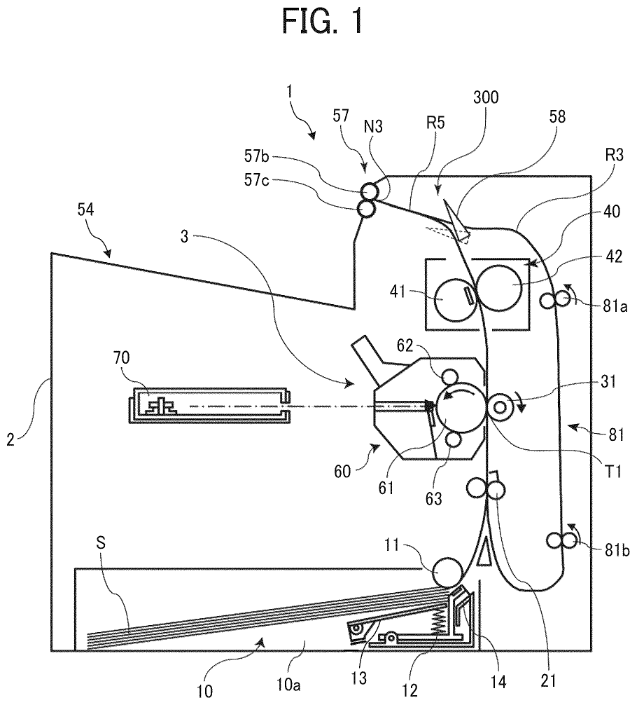

FIG. 1 is a diagram illustrating a schematic configuration of an image forming apparatus 1 according to an embodiment of the present disclosure.

A process cartridge 3 is provided inside an apparatus body 2 of the image forming apparatus 1.

The process cartridge 3 includes, for example, a photoconductor 61 as a latent image bearer, a charging device 62 as a process unit that is disposed around the photoconductor 61 and acts on the photoconductor 61, a developing device 60, and a cleaning device. The process cartridge 3 is detachably attached to the apparatus body 2. When the photoconductor 61, the charging device 62, the developing device 60, and the cleaning device are unitized as the process cartridge 3, replacement and maintenance work are facilitated. In addition, positional accuracy between the members can be maintained with high accuracy, and image quality to be formed can be improved.

The transfer device as a transfer unit includes a transfer roller 31, and the transfer roller 31 is pressed against and in contact with the peripheral surface of the photoconductor 61. A fixing device 40 as a fixing unit is provided above the transfer device. The fixing device 40 includes a heating roller 41 as a heating member and a pressure roller 42 as a pressure member. The apparatus body 2 is provided with a laser writing device 70 as a latent image forming unit. The laser writing device 70 includes, for example, a laser light source, a rotating polygon mirror for scanning, a polygon motor, and an fθ lens.

The apparatus body 2 includes a sheet cassette 10 that stores a sheet S such as a transfer sheet or an overhead projector (OHP) film. The sheet cassette 10 includes a tray 10a as a structural body and a bottom plate 13 provided inside the tray 10a.

The sheet S is stacked on the bottom plate 13 and stored in the tray 10a. A pressure spring 12 is provided between a lower face of the bottom plate 13 and an inner bottom face of the tray 10a. As a result of a biasing force of the pressure spring 12 biasing a downstream portion of the bottom plate 13 in a sheet feeding direction upward, the sheet S on the bottom plate 13 comes into contact with the sheet feed roller 11 at a sheet feeding pressure within a given range.

When printing is performed using the apparatus having the above configuration, a photoconductor driving motor rotates the photoconductor 61, and the charging device 62 uniformly charges the face of the photoconductor 61. Subsequently, a writing procedure is executed using the laser writing device 70 by irradiating laser light according to image data received from an external device such as a personal computer or an image reading device. Then, after an electrostatic latent image is formed on the surface of the photoconductor 61, toner is attached using the developing roller 63 of the developing device 60 to visualize (develop) the electrostatic latent image.

The sheet S in the sheet cassette 10 is sent out from the cassette by rotational driving of the sheet feed roller 11, and only the uppermost sheet is separated and sent out at the separation nip between the sheet feed roller 11 and the separation pad 14. The fed sheet S abuts against a registration roller 21 and is stopped. Then, the sheet is sent to a transfer nip T1, which is formed by the transfer roller 31 abutting against the photoconductor 61, in synchronization with a rotation timing of a toner image visualized on the photoconductor 61.

The toner image on the photoconductor 61 is transferred to the sheet S fed to the transfer nip T1 by the transfer roller 31. The residual toner on the photoconductor 61 after the image transfer is removed and cleaned by the cleaning device, and the residual potential on the photoconductor 61 from which the residual toner has been removed is removed by a static eliminator. Then, preparation is made for the subsequent image formation starting from the charging device 62. The residual toner removed by the cleaning device is conveyed to a waste toner bottle.

On the other hand, the sheet S after the image transfer is guided to the fixing device 40, passed between the heating roller 41 and the pressure roller 42, and while being conveyed to these rollers, heat and pressure are applied to fix the toner image. The sheet S on which the image is fixed is conveyed to a sheet ejector 300.

The sheet ejector 300 includes a switching claw 58 and a pair of sheet ejection reverse rollers 57 including a sheet ejection reverse drive roller 57b and a sheet ejection reverse driven roller 57c. The pair of sheet ejection reverse rollers 57 ejects the conveyed sheet S to a sheet ejection stack unit 54, and when a duplex print mode is set, the pair of sheet ejection reverse rollers 57 is reversed to switch back the sheet S to the re-feeding path 81 side.

In a case where the one-sided print mode for forming an image on only one side of the sheet S is set, the sheet S on which the image is fixed is ejected onto the sheet ejection stack unit 54 by the pair of sheet ejection reverse rollers 57 and is stacked.

In a case where the duplex print mode is set, when a trailing edge of the sheet S on which the image is fixed passes through the switching claw 58, the switching claw 58 is rotated counterclockwise in the diagram to assume the attitude of the broken line in the diagram. The sheet ejection reverse drive roller 57b is reversely rotated to switch back the sheet S, and the sheet S is conveyed to a duplex conveyance path R3. Thus, the sheet S is conveyed by a pair of re-conveyance rollers 81a and 81b of the re-feeding path 81, and is conveyed to the transfer nip T1 again in a state where the front and back sides of the sheet S are reversed in a direction in which a toner image can be transferred to the back face of the sheet S. Then, after the toner image is formed on the back face of the sheet S by passing through the transfer nip T1, the toner image is fixed to the sheet S by the fixing device 40.

During a period from when the trailing edge of the sheet S that has been switchback-conveyed passes through the switching claw 58 to when the leading edge of the sheet having the image fixed on the back face reaches the switching claw 58, the switching claw 58 is rotated clockwise in the diagram and is changed to the attitude indicated by the solid line in the diagram. Thus, the sheet S image-fixed on both sides is conveyed to a sheet ejection path R5 by the switching claw 58, and is ejected to the sheet ejection stack unit 54 by the pair of sheet ejection reverse rollers 57.

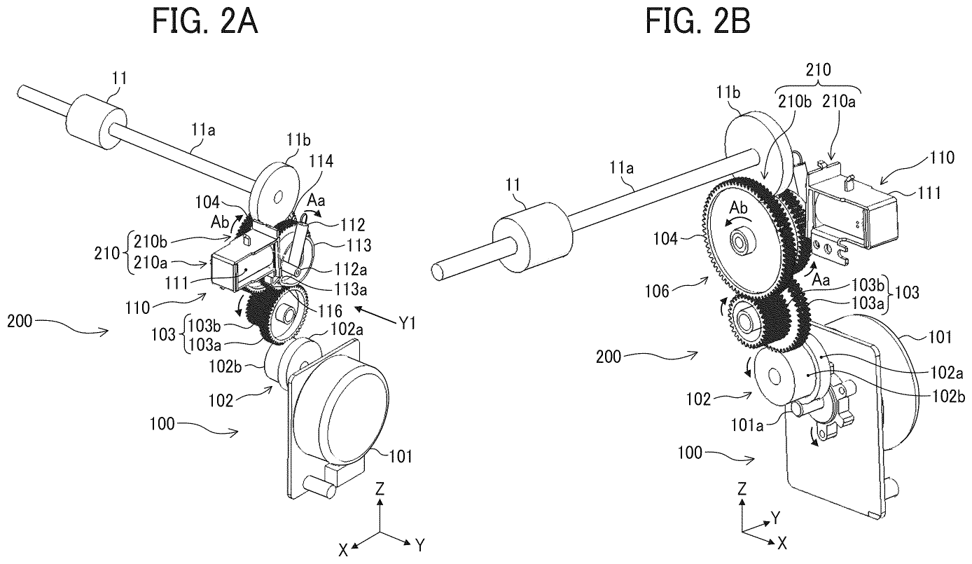

FIGS. 2A and 2B are perspective views of a schematic configuration of a sheet feeding drive device 100 that drives the sheet feed roller 11.

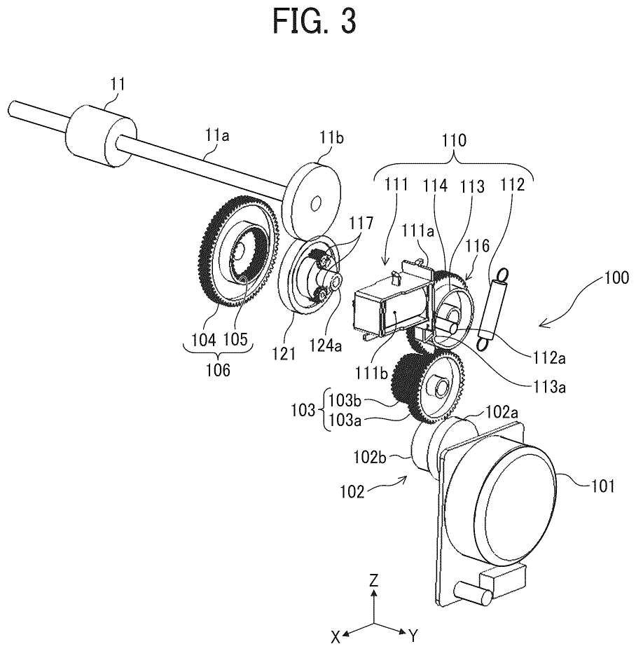

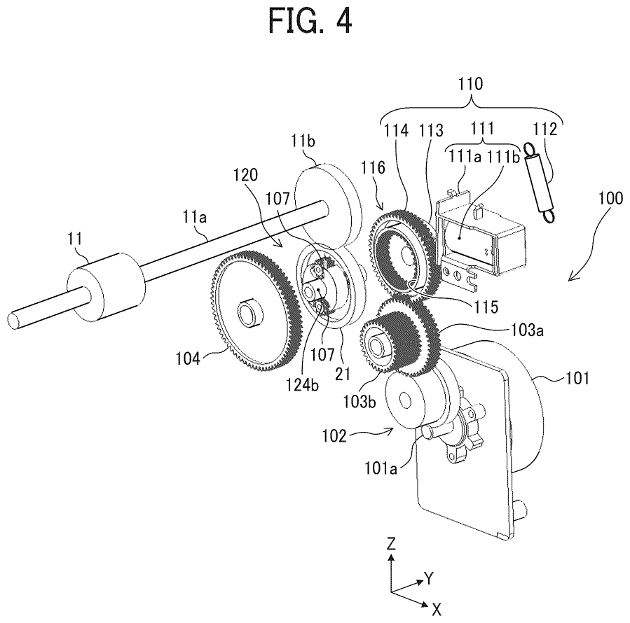

FIGS. 3 and 4 are exploded perspective views of the sheet feeding drive device 100.

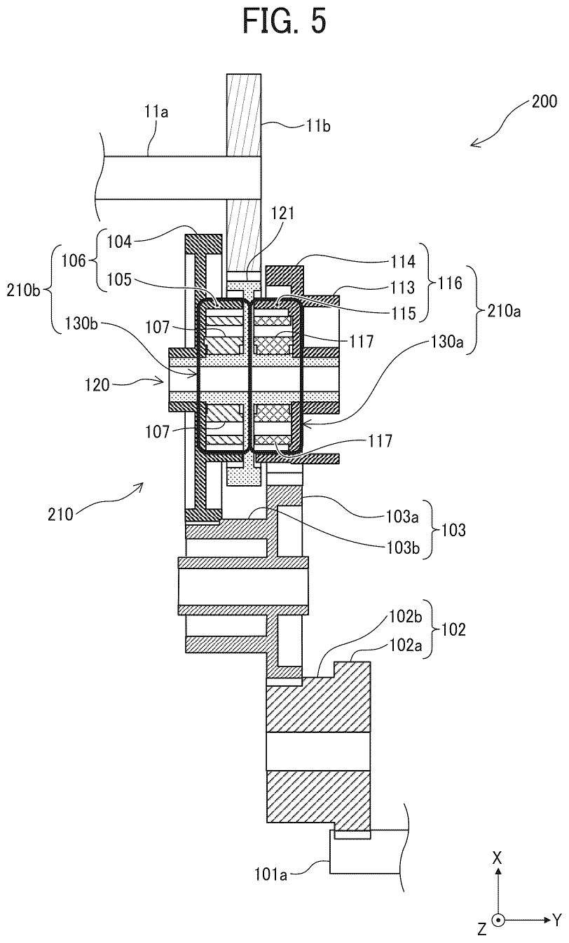

FIG. 5 is a cross-sectional view of a schematic configuration of the drive transmission unit 200 as a drive transmission device.

The sheet feeding drive device 100 includes a sheet feeding motor 101 as a drive source, and a drive transmission unit 200 as a drive transmission device that transmits the driving force of the sheet feeding motor 101 to the sheet feed roller 11.

The drive transmission unit 200 includes a first gear 102, an input gear 103, a transmission mechanism 210, and a roller gear 11b.

The transmission mechanism 210 includes a high-speed drive transmission path 210a as a first drive transmission path that rotates the sheet feed roller 11 at a high speed, and a low-speed drive transmission path 210b as a second drive transmission path that rotates the sheet feed roller 11 at a low speed. The high-speed drive transmission path 210a mainly includes a single rotation clutch mechanism 110 and a high-speed side one-way clutch mechanism 130a, and the low-speed drive transmission path 210b mainly includes a low-speed gear 106 and a low-speed side one-way clutch mechanism 130b. As described below, the rotation speed of the sheet feed roller 11 is switched by selectively switching the drive transmission path between the high-speed drive transmission path 210a and the low-speed drive transmission path 210b.

The first gear 102 is a stepped gear, a large-diameter gear 102a meshes with a motor gear 101a of the sheet feeding motor 101, and a small-diameter gear 102b meshes with a high-speed side input gear 103a of the input gear 103.

The input gear 103 is a stepped gear, and includes a large-diameter high-speed side input gear 103a and a small-diameter low-speed side input gear 103b. The high-speed side input gear 103a meshes with the small-diameter gear 102b of the first gear 102 and a mutilated gear 114 of the single rotation clutch mechanism 110 to transmit the driving force of the sheet feeding motor 101 to the high-speed drive transmission path 210a of the transmission mechanism 210. On the other hand, the low-speed side input gear 103b meshes with an external teeth 104 of the low-speed gear 106 to transmit the driving force of the sheet feeding motor 101 to the low-speed drive transmission path 210b of the transmission mechanism 210.

The high-speed drive transmission path 210a as the first drive transmission path of the transmission mechanism 210 is mainly configured by the single rotation clutch mechanism 110 and the high-speed side one-way clutch mechanism 130a (see FIG. 5). The single rotation clutch mechanism 110 includes a mutilated gear 114 and a cam 113 provided in a high-speed gear 116, a flapper solenoid 111, and a tension spring 112 as a biasing member. The flapper solenoid 111 includes a flapper 111a as a restricting member and a solenoid 111b as an actuator.

The high-speed side one-way clutch mechanism 130a is of a planetary gear type, and includes a high-speed side internal teeth 115 (see FIG. 4) provided in the high-speed gear 116, two high-speed side planetary gears 117 (see FIG. 3), and a common planet carrier 120. The common planet carrier 120 has an output gear 121 that meshes with the roller gear 11b. The roller gear 11b is attached to one end of a shaft 11a of the sheet feed roller 11.

The high-speed gear 116 including the mutilated gear 114, the cam 113, and the high-speed side internal teeth 115 is provided with a spring engagement portion 112a for engaging one end of the tension spring 112. The high-speed gear 116 is rotatably supported by the first shaft 124a of the common planet carrier 120.

The low-speed drive transmission path 210b as the second drive transmission path of the transmission mechanism 210 includes a low-speed gear 106 and a low-speed side one-way clutch mechanism 130b (see FIG. 5). The low-speed gear 106 includes the external teeth 104 and a low-speed side internal teeth 105 (see FIGS. 3 and 5).

The low-speed side one-way clutch mechanism 130b is also of a planetary gear type, and includes a low-speed side internal teeth 105, two low-speed side planetary gears 107 (see FIG. 4) as second planetary gears, and the common planet carrier 120. The low-speed gear 106 is rotatably held by the second shaft 124b of the common planet carrier 120.

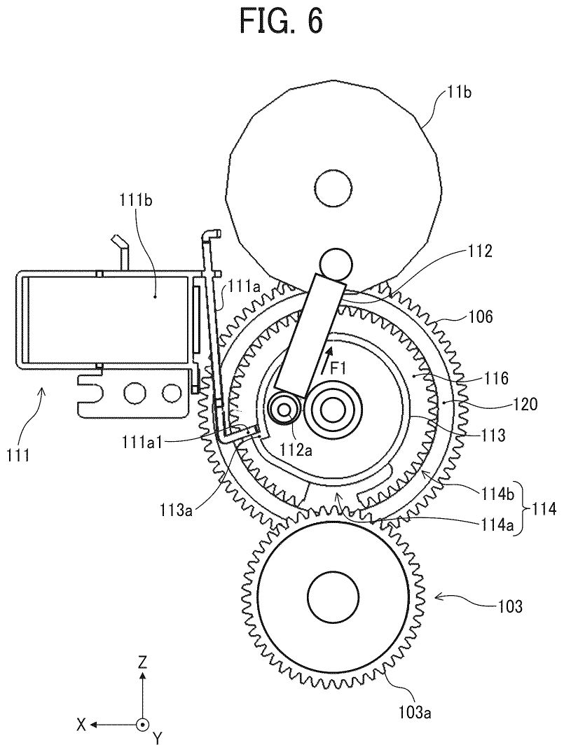

FIG. 6 is a diagram illustrating a configuration of the single rotation clutch mechanism 110, and is a schematic view as viewed from a direction of an arrow Y1 in FIGS. 2A and 2B.

The cam 113 of the single rotation clutch mechanism 110 is provided with a stepped portion 113a as an engagement portion. When a toothless portion 114a of the mutilated gear 114 is located at a meshing position with the high-speed side input gear 103a as illustrated in FIG. 6, a flapper distal end 111a1 is in contact with the stepped portion 113a of the cam 113. In the state of FIG. 6, the high-speed gear 116 is biased in an arrow direction F1 in FIG. 6 by a tension spring 112.

In the state of FIG. 6, the single rotation clutch mechanism 110 is in a state in which the drive transmission from the high-speed side input gear 103a to the high-speed gear 116 is cut off. When the solenoid 111b is driven from the state illustrated in FIG. 6 to suck the flapper 111a, the engagement between the flapper distal end 111a1 and the stepped portion 113a of the cam 113 is released. When this engagement is released, the high-speed gear 116 rotates in the clockwise direction in FIG. 6 by the biasing force of the tension spring 112. Then, the gear 114b of the mutilated gear 114 meshes with the high-speed side input gear 103a, and the driving force of the sheet feeding motor 101 is transmitted to the high-speed gear 116.

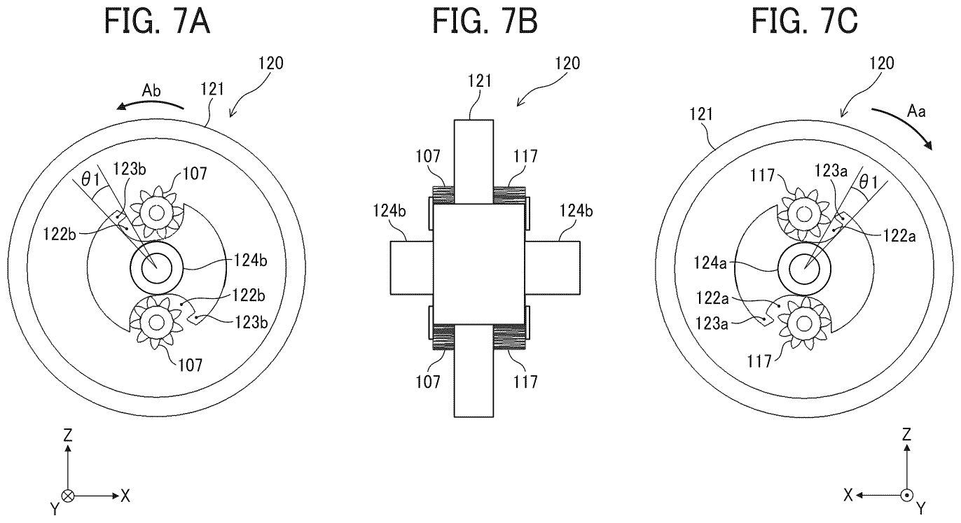

A description is given of the low-speed side one-way clutch mechanism 130b and the high-speed side one-way clutch mechanism 130a with reference to FIGS. 7A to 7C.

FIGS. 7A to 7C are diagrams illustrating a schematic configuration of the common planet carrier 120.

First, a description is given of the low-speed side one-way clutch mechanism 130b.

As illustrated in FIG. 7A, a low-speed side recess 122b for holding the low-speed side planetary gear 107 is provided on a left side face (face opposing the low-speed gear 106) of the common planet carrier 120. The low-speed side planetary gear 107 is held in the low-speed side recess 122b so as to be movable in the circumferential direction at a given rotation angle θ1 of the common planet carrier 120. In the present embodiment, the rotation angle θ1 is 13 degrees.

A low-speed side rotation stopper 123b that engages with the low-speed side planetary gear 107 and stops the rotation of the low-speed side planetary gear 107 is provided at a downstream end of the low-speed side recess 122b in a rotation direction (direction of arrow Ab in FIG. 7A) of the low-speed gear 106.

When the low-speed gear 106 relatively rotates clockwise in FIG. 7A (direction opposite to the direction of arrow Ab, the other direction) relative to the common planet carrier 120, the low-speed side planetary gear 107 is located on the upstream side in the rotation direction (direction of arrow Ab in FIG. 7A) of the low-speed gear 106 in the low-speed side recess 122b. At this time, the low-speed side planetary gear 107 is rotatably held in the low-speed side recess 122b. Thus, the low-speed side planetary gear 107 idles in the low-speed side recess 122b, and the drive transmission between the low-speed gear 106 and the common planet carrier 120 is interrupted.

On the other hand, when the low-speed gear 106 relatively rotates counterclockwise in FIG. 7A (direction of arrow Ab, one direction) relative to the common planet carrier 120, the low-speed side planetary gear 107 meshing with the low-speed side internal teeth 105 of the low-speed gear 106 moves counterclockwise (in the direction of arrow Ab) in the low-speed side recess 122b, engages with the low-speed side rotation stopper 123b, and stops rotating. Thus, the common planet carrier 120 rotates integrally with the low-speed gear 106, and drive transmission is performed between the low-speed gear 106 and the common planet carrier 120 via the low-speed side planetary gear 107.

A description is now given of the high-speed side one-way clutch mechanism 130a.

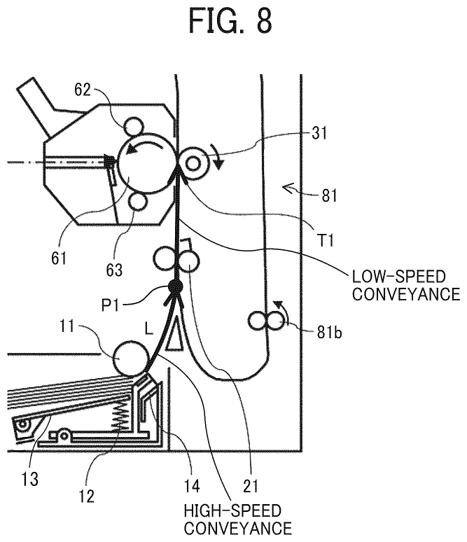

As illustrated in FIG. 7C, a high-speed side recess 122a that holds the high-speed side planetary gear 117 is provided on a right side face (face opposing the high-speed gear 116) of the common planet carrier 120. Similarly to the low-speed side, the high-speed side planetary gear 117 is also held in the high-speed side recess 122a so as to be movable in the circumferential direction at the given rotation angle θ1 (see FIG. 8B) of the common planet carrier 120.

Similarly to the low-speed side recess 122b, the high-speed side recess 122a is also provided with a high-speed side rotation stopper 123a that engages with the high-speed side planetary gear 117 and stops the rotation of the high-speed side planetary gear 117 at a downstream end in a rotation direction (direction of the arrow Aa in the figure) of the high-speed gear 116.

Also in the high-speed side one-way clutch mechanism 130a, similarly to the low-speed side one-way clutch mechanism 130b, driving in one direction is transmitted with reference to the common planet carrier 120, and driving transmission in the other direction is interrupted. That is, when the high-speed gear 116 relatively rotates counterclockwise in FIG. 7C (direction opposite to the direction of arrow Aa, the other direction) relative to the common planet carrier 120, the high-speed side planetary gear 117 is located on the upstream side in the rotation direction (direction of arrow Aa in FIG. 7C) of the high-speed gear 116 in the high-speed side recess 122a. At this time, the high-speed side planetary gear 117 is rotatably held in the high-speed side recess 122a. Thus, the high-speed side planetary gear 117 idles in the high-speed side recess 122a, and the drive transmission between the high-speed gear 116 and the common planet carrier 120 is interrupted.

On the other hand, when the high-speed gear 116 relatively rotates clockwise in FIG. 7C (direction of arrow Aa, one direction) relative to the common planet carrier 120, the high-speed side planetary gear 117 moves clockwise (direction of arrow Aa) in the high-speed side recess 122a. Then, the rotation of the high-speed side planetary gear 117 is stopped by engaging with the high-speed side rotation stopper 123a. Thus, the common planet carrier 120 rotates integrally with the high-speed gear 116, and drive transmission is performed between the high-speed gear 116 and the common planet carrier 120 via the high-speed side planetary gear 117.

Table 1 below indicates the rotation speed of each of the low-speed gear 106, the high-speed gear 116, and the common planet carrier 120 when the sheet feed roller 11 is rotated at a low speed, and the relative rotation speed of each gear with respect to the common planet carrier 120. In Table 1 below, the rotation direction of the low-speed gear 106 is positive, and the direction opposite to the rotation direction of the low-speed gear 106 is negative.

TABLE 1

| | Low-speed | High-speed | Common planet |
|---|---|---|---|
| | gear | gear | carrier |
| Rotation speed | 100 | 0 | 100 |
| Relative rotation speed | 0 | −100 | 0 |
| with reference to | | | |
| common planet carrier | | | |

When the sheet feed roller 11 is rotated at a low speed, as illustrated in FIG. 6, the rotation of the high-speed gear 116 is stopped by the flapper 111a in a state where the toothless portion 114a of the mutilated gear 114 is located at a meshing position with the high-speed side input gear 103a. Therefore, the rotation speed of the high-speed gear 116 is 0. On the other hand, the driving force of the sheet feeding motor 101 is transmitted from the low-speed side input gear 103b, and the low-speed gear 106 rotates at a rotation speed of 100 [rpm].

At this time, the low-speed gear 106 relatively rotates counterclockwise in FIG. 7A (direction of arrow Ab, one direction) relative to the common planet carrier 120. Therefore, the low-speed side planetary gear 107 of the low-speed side one-way clutch mechanism 130b moves counterclockwise (direction of arrow Ab) in the low-speed side recess 122b, engages with the low-speed side rotation stopper 123b, and stops rotating. Thus, the common planet carrier 120 rotates integrally with the low-speed gear 106 at a rotation speed of 100 [rpm].

As the common planet carrier 120 rotates at the rotation speed of 100 [rpm], as indicated in Table 1, the stopped high-speed gear 116 relatively rotates with reference to the common planet carrier 120 at −100 [rpm] (rotates in the other direction). As a result, the high-speed side planetary gear 117 meshing with the high-speed side internal teeth 115 of the stopped high-speed gear 116 moves to the position illustrated in FIG. 7C. Thus, drive transmission between the high-speed gear 116 and the common planet carrier 120 is interrupted, and the high-speed gear 116 does not rotate together with the common planet carrier 120.

Table 2 below indicates the rotation speed of each of the low-speed gear 106, the high-speed gear 116, and the common planet carrier 120 when the sheet feed roller 11 is rotated at a high speed, and the relative rotation speed of each gear with reference to the common planet carrier 120. In Table 2 below, the rotation direction of the low-speed gear 106 is positive, and the direction opposite to the rotation direction of the low-speed gear 106 is negative.

TABLE 2

| | Low-speed | High-speed | Common planet |
|---|---|---|---|
| | gear | gear | carrier |
| Rotation speed | 100 | 199 | 199 |
| Relative rotation speed | −99 | 0 | 0 |
| with reference to | | | |
| common planet carrier | | | |

When the solenoid 111b is turned on to release the engagement between the flapper distal end 111a1 and the stepped portion 113a of the cam 113, the gear 114b of the mutilated gear 114 of the single rotation clutch mechanism 110 meshes with the high-speed side input gear 103a. As a result, the high-speed gear 116 rotates at a rotation speed of 199 [rpm]. On the other hand, the driving force of the sheet feeding motor 101 is transmitted from the low-speed side input gear 103b, and the low-speed gear 106 rotates at a rotation speed of 100 [rpm].

Before the start of rotation of the high-speed gear 116, the low-speed side planetary gear 107 of the low-speed side one-way clutch mechanism 130b is engaged with the low-speed side rotation stopper 123b, and the common planet carrier 120 rotates at a rotation speed of 100 [rpm] together with the low-speed gear 106. Therefore, immediately after the high-speed gear 116 starts rotating at the rotation speed of 199 [rpm], the high-speed gear 116 rotates 99 [rpm] faster than the common planet carrier 120. Accordingly, the high-speed gear 116 relatively rotates clockwise in FIG. 7C (direction of arrow Aa, one direction) with reference to the common planet carrier 120. Therefore, the high-speed side planetary gear 117 of the high-speed side one-way clutch mechanism 130a moves in the high-speed side recess 122a in the clockwise direction (direction of arrow Aa) in FIG. 7C, and is engaged with the high-speed side rotation stopper 123a to stop the rotation. Thus, the common planet carrier 120 rotates integrally with the high-speed gear 116, and the common planet carrier 120 is accelerated from 100 [rpm] to 199 [rpm].

When the common planet carrier 120 rotates at 199 [rpm], the low-speed gear 106 relatively rotates with reference to the common planet carrier 120 at −99 [rpm] (rotates in the other direction), as illustrated in Table 2. As a result, the low-speed side planetary gear 107 meshing with the low-speed side internal teeth 105 of the low-speed gear 106 moves to the position illustrated in FIG. 7A. Thus, drive transmission between the low-speed gear 106 and the common planet carrier 120 is interrupted, and the low-speed gear 106 does not rotate together with the common planet carrier 120.

As described above, in the present embodiment, the drive transmission path between the high-speed drive transmission path 210a and the low-speed drive transmission path 210b is selectively switched by switching a drive transmission state/drive cutoff state of the single rotation clutch mechanism 110.

In a case where the electromagnetic clutch is used instead of the single rotation clutch mechanism 110, it is necessary to keep the electromagnetic clutch on when the driving force is transmitted via the high-speed drive transmission path 210a, and power is continuously consumed during the driving force transmission via the high-speed drive transmission path 210a.

On the other hand, in the case of the single rotation clutch mechanism 110, the solenoid 111b is turned on only when the engagement between the flapper distal end 111a1 and the stepped portion 113a of the cam 113 is released. Then, when the high-speed gear 116 (mutilated gear 114) rotates by the biasing force of the tension spring 112, the solenoid 111b is turned off. Even when the solenoid 111b is turned off, the driving force of the sheet feeding motor 101 is transmitted, and the driving force is transmitted via the high-speed drive transmission path 210a. As described above, unlike the electromagnetic clutch, the single rotation clutch mechanism 110 does not consume power during the transmission of the driving force via the high-speed drive transmission path 210a, so that energy saving can be achieved as compared with the case of using the electromagnetic clutch.

In the present embodiment, the high-speed side one-way clutch mechanism 130a and the low-speed side one-way clutch mechanism 130b are used to switch the drive transmission path between the high-speed drive transmission path 210a and the low-speed drive transmission path 210b in conjunction with the drive transmission/drive interruption of the single rotation clutch mechanism 110. Thus, the drive transmission path can be switched to be selected between the high-speed drive transmission path 210a and the low-speed drive transmission path 210b in conjunction with the drive transmission/drive interruption of the single rotation clutch mechanism 110 without using electricity, and energy saving can be achieved.

A description is now given of rotational driving of the sheet feed roller 11.

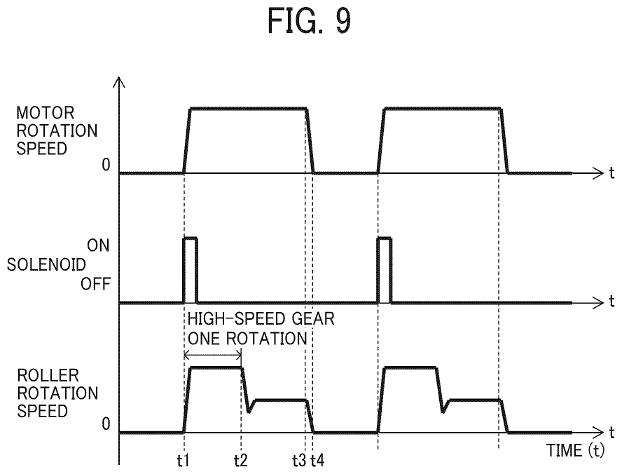

FIG. 8 is a diagram illustrating conveyance of the sheet S up to the transfer nip T1, and FIG. 9 is a sequence diagram of sheet feeding.

As illustrated in FIG. 9, the solenoid 111b of the single rotation clutch mechanism 110 is turned on at a timing (time t1) when the sheet feeding motor 101 is turned on to start feeding of the sheet S in the sheet cassette 10. Thus, the engagement between the flapper distal end 111a1 and the stepped portion 113a of the cam 113 is released, and the gear 114b of the mutilated gear 114 meshes with the high-speed side input gear 103a. Therefore, the driving force of the sheet feeding motor 101 is transmitted to the sheet feed roller 11 as the output target rotary body via the high-speed drive transmission path 210a, and the sheet feed roller 11 rotates at the first speed. The solenoid 111b is turned off at a given timing after the high-speed gear 116 starts to rotate by the biasing force of the tension spring 112.

At time t2 (time when the sheet S is conveyed by the distance L as illustrated in FIG. 8) when the leading edge of the sheet S reaches the point P1 (see FIG. 8) in front of the registration roller 21, the high-speed gear 116 (mutilated gear 114) makes one rotation, and the flapper distal end 111a1 and the stepped portion 113a of the cam 113 are engaged with each other. Thus, the drive transmission between the mutilated gear 114 and the high-speed side input gear 103a is interrupted, and the rotation of the high-speed gear 116 is stopped.

When the rotation of the high-speed gear 116 is stopped, as described above, the low-speed side planetary gear 107 moves in the low-speed side recess 122b and engages with the low-speed side rotation stopper 123b. Thus, the driving force of the sheet feeding motor 101 is transmitted to the sheet feed roller 11 via the low-speed drive transmission path 210b, and the sheet feed roller 11 rotates at the second speed slower than the first speed. Then, at time t3 when the trailing edge of the sheet S passes through the sheet feed roller 11, the sheet feeding motor 101 is turned off.

The time for driving the sheet feed roller 11 at the first speed is obtained by dividing the conveyance distance L from the sheet feed roller 11 to the position in front of the registration roller 21 by the sheet line speed. The sheet line speed is πD×(N₂/60) [mm/s], where D is the diameter of the sheet feed roller 11, and N₂ is the rotation speed of the sheet feed roller 11 during high-speed rotation. The time during which the high-speed gear 116 makes one rotation is the same as the time during which the sheet feed roller 11 is driven at the first speed, and the time during which the high-speed gear 116 makes one rotation is 1/(N₁/60) where N₁ is the rotation speed of the high-speed gear 116. Therefore, the reduction ratio (N₁/N₂) between the high-speed gear 116 and the sheet feed roller 11 is expressed by the following Formula 1.

(N₁/N₂)=(πD/L) (Formula 1)

The rotation speed N₁ of the high-speed gear 116 is obtained from the above Formula 1. A reduction ratio between the high-speed gear 116 and the roller gear 11b is set so as to be (N₁/N₂). Thus, at the time of high-speed driving, the sheet feed roller 11 can be rotationally driven at the target rotation speed N₂. The rotation speed of the sheet feeding motor 101 is set so as to obtain the necessary torque at the time of the high-speed rotation of the sheet feed roller 11. Then, the reduction ratio of the high-speed gear 116 from the sheet feeding motor 101 is set from the rotation speed of the sheet feeding motor and the obtained rotation speed N₁ of the high-speed gear 116. Thus, the high-speed gear 116 can be rotationally driven at the target rotation speed N₁.

As described above, in the present embodiment, the sheet S can be conveyed at high speed until the leading edge of the sheet S reaches the position in front of the registration roller 21, and the productivity can be enhanced. The rotation speed of the sheet feed roller 11 can be switched without changing the rotation speed of the sheet feeding motor 101. Therefore, other rotating bodies (for example, the registration roller 21) can be rotationally driven by the sheet feeding motor 101 without causing speed fluctuation. The rotation speed of the sheet feed roller 11 can be increased without increasing the rotation speed of the sheet feeding motor 101, and energy saving and noise reduction can be achieved.

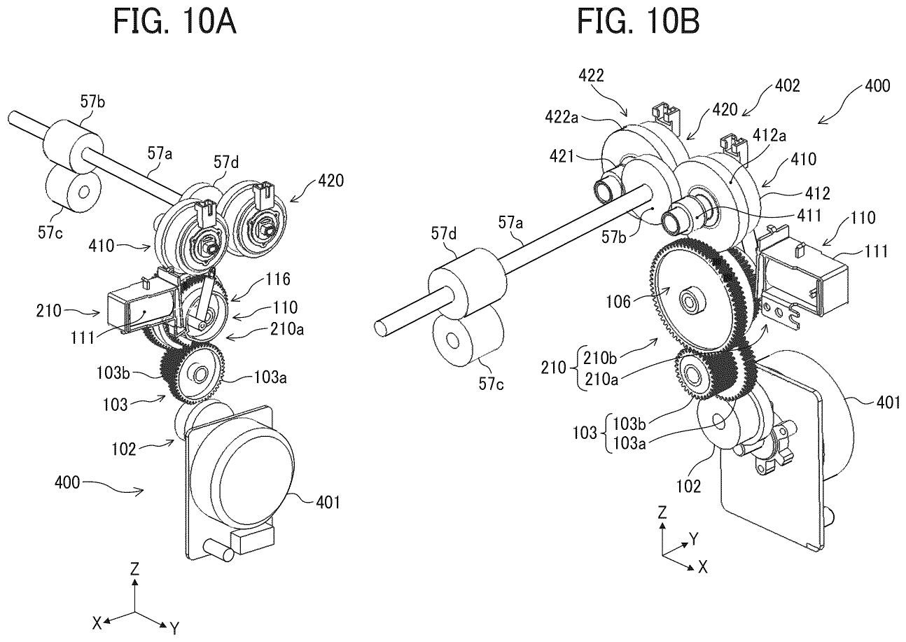

FIGS. 10A and 10B are perspective views of a schematic configuration of the sheet ejection drive device 400 that drives the pair of sheet ejection reverse rollers 57.

The sheet ejection drive device 400 includes a sheet ejection motor 401 as a drive source, and a sheet ejection drive transmission unit 402 as a drive transmission device that transmits a driving force of the sheet ejection motor 401 to the sheet ejection reverse drive roller 57b of the pair of sheet ejection reverse rollers 57. The configuration from the sheet ejection motor 401 of the sheet ejection drive transmission unit 402 to the common planet carrier 120 is the same as that of the sheet feeding drive device 100.

The sheet ejection drive transmission unit 402 includes a forward rotation drive path 420 that normally rotates the sheet ejection reverse drive roller 57b and a reverse rotation drive transmission path 410 that reversely rotates the sheet ejection reverse drive roller 57b. The forward rotation drive path 420 includes a forward gear 421 that meshes with a roller gear 57d attached to one end of the shaft 57a of the sheet ejection reverse drive roller 57b, and a forward clutch 422. The forward clutch 422 is an electromagnetic clutch and is attached to a shaft portion of the forward gear 421. A gear 422a of the forward clutch 422 meshes with a gear 412a of a reverse clutch 412.

The reverse rotation drive transmission path 410 includes a reverse rotation gear 411 meshing with the roller gear 57d and a reverse clutch 412. The reverse clutch 412 is an electromagnetic clutch, and is attached to a shaft portion of the reverse rotation gear 411. The gear 412a of the reverse clutch 412 meshes with the output gear 121 of the common planet carrier 120 and the gear 422a of the forward clutch 422.

When the sheet ejection reverse drive roller 57b is rotated forward, the forward clutch 422 is turned on and the reverse clutch 412 is turned off. Thus, the gear 412a of the reverse clutch 412 idles with respect to the reverse rotation gear 411. On the other hand, the driving force of the sheet ejection motor 401 is transmitted to the roller gear 57d via the gear 412a of the reverse clutch 412, the forward clutch 422, and the forward gear 421, and the sheet ejection reverse drive roller 57b rotates forward.

When the sheet ejection reverse drive roller 57b is reversely rotated, the forward clutch 422 is turned off and the reverse clutch 412 is turned on. Thus, the gear 422a of the forward clutch 422 idles with respect to the forward gear 421. On the other hand, the driving force of the sheet ejection motor 401 is transmitted to the roller gear 57d via the reverse clutch 412, and the sheet ejection reverse drive roller 57b reversely rotates.

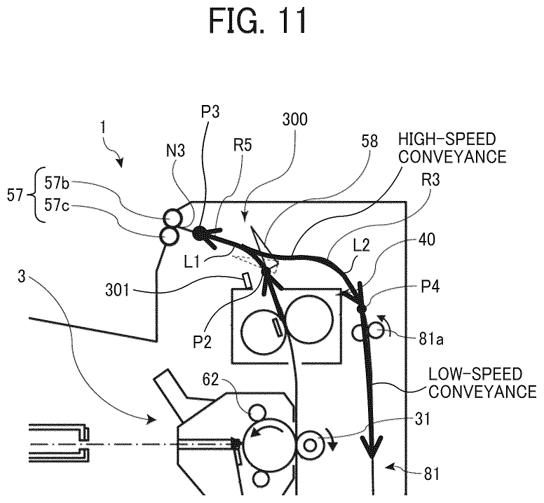

FIG. 11 is a diagram illustrating the switchback conveying of the sheet S when the duplex print mode is set.

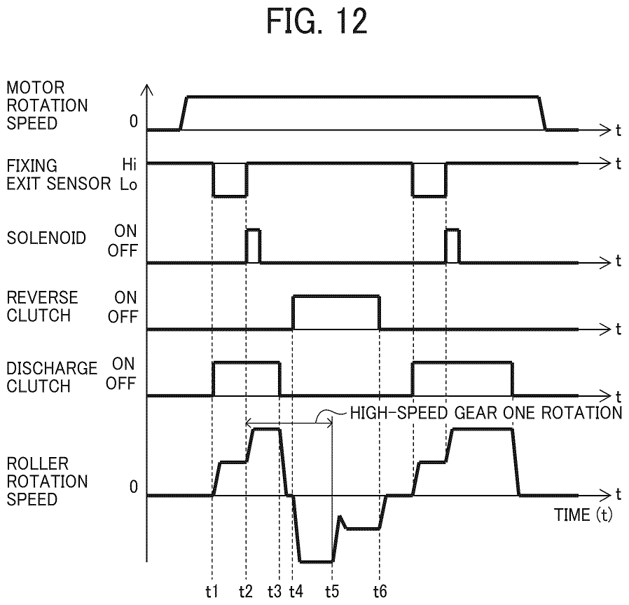

FIG. 12 is a sequence diagram of the switchback conveying.

As illustrated in FIG. 11, when a fixing exit sensor 301 that detects a sheet provided at the exit of the fixing device 40 detects the leading edge of the sheet (time t1), the forward clutch 422 is turned on, and the sheet ejection reverse drive roller 57b is rotated forward.

When the fixing exit sensor 301 detects the trailing edge of the sheet (time t2 in FIG. 12), the solenoid 111b is turned on to release the engagement between the flapper distal end 111a1 and the stepped portion 113a of the cam 113. Thus, the drive transmission path in the transmission mechanism 210 is switched from the low-speed drive transmission path 210b to the high-speed drive transmission path 210a. As a result, the rotation speed of the sheet ejection reverse drive roller 57b increases, and the conveyance speed of the sheet S increases.

When the trailing edge of the sheet reaches a switchback stop position P3 illustrated in FIG. 11 (time t3 in FIG. 12), the forward clutch 422 is turned off and the reverse clutch 412 is turned on. Thus, the sheet ejection reverse drive roller 57b reversely rotates, and the sheet S is switchback conveyed to the duplex conveyance path R3. At this time, since the high-speed gear 116 (mutilated gear 114) is not rotating once, the sheet S is conveyed to the duplex conveyance path R3 at a high conveyance speed.

At a timing when the leading edge of the sheet after the switchback conveying reaches a position P4 in front of the pair of re-conveyance rollers 81a illustrated in FIG. 11 (time t5 in FIG. 12), the high-speed gear 116 (mutilated gear 114) makes one rotation, and the flapper distal end 111a1 and the stepped portion 113a of the cam 113 are engaged. Thus, the drive transmission between the mutilated gear 114 and the high-speed side input gear 103a is interrupted, and the rotation of the high-speed gear 116 is stopped. Therefore, the drive transmission path of the transmission mechanism 210 is switched from the high-speed drive transmission path 210a to the low-speed drive transmission path 210b. As a result, the rotation speed of the sheet ejection reverse drive roller 57b decreases, and the conveyance speed of the sheet S decreases.

Then, when the trailing edge of the sheet S passes through the pair of sheet ejection reverse rollers 57 (time t6 in FIG. 12), the reverse clutch 412 is turned off, and the drive of the sheet ejection reverse drive roller 57b is stopped.

As described above, the sheet can be conveyed at high speed from when the trailing edge of the sheet passes through the fixing device 40 to when the leading edge of the sheet reaches before the pair of re-conveyance rollers 81a, and the productivity of duplex printing can be enhanced.

At the time of discharging the sheet S to the sheet ejection stack unit 54, when the fixing exit sensor 301 detects the leading edge of the sheet, the forward clutch is turned on to start the forward rotation of the sheet ejection reverse drive roller 57b. When the fixing exit sensor 301 detects the trailing edge of the sheet, the solenoid 111b is turned on to release the engagement between the flapper distal end 111a1 and the stepped portion 113a of the cam 113, and the rotation speed of the sheet ejection reverse drive roller 57b is increased to increase the conveyance speed of the sheet S. When the trailing edge of the sheet passes through the pair of sheet ejection reverse rollers 57, the forward clutch is turned off to stop the rotation of the sheet ejection reverse drive roller 57b. Thus, the sheet ejection time of the sheet S can be shortened, and productivity can be enhanced. By enhancing the productivity, the travel distance of each unit can be suppressed, and the life of the image forming apparatus can be extended.

Assuming that N₃ is the rotation speeds of the sheet ejection reverse drive roller 57b at the time of high-speed rotation, D1 is the diameter of the sheet ejection reverse drive roller 57b, N₁ is the rotation speeds of the high-speed gear 116, L1 is the distance from a sheet detection position (P2 in FIG. 11) of the fixing exit sensor 301 to the switchback stop position P3 at the trailing edge of the sheet, and L2 is the distance from the switchback stop position P3 to the position P4 before the pair of re-conveyance rollers 81a, a relationship represented by the following Formula 2 is established. The following Formula 2 is obtained by replacing N₂ in Formula 1 with N₃, D with D1, and L with (L1+L2).

(N₁/N₃)=(πD1/L1+L2) (Formula 2)

Since the rotation speed N₁ of the high-speed gear 116 is obtained from the above Formula 2, the reduction ratio from the high-speed gear 116 to the roller gear 57d is set on the basis of the obtained rotation speed N₁ so that the sheet ejection reverse drive roller 57b attains the target rotation speed N₃. The rotation speed of the sheet ejection motor 401 and the reduction ratio from the sheet ejection motor 401 to the high-speed gear 116 are set to attain the obtained rotation speed N₁. Thus, when the sheet S is conveyed by the distance L1+L2, the high-speed gear 116 (mutilated gear 114) can rotate once.

In the above description, the planetary gear type one-way clutch mechanism is provided in each of the drive transmission paths 210a and 210b, but the one-way clutch mechanism is not limited to the planetary gear type, and a general roller type one-way clutch can also be used.

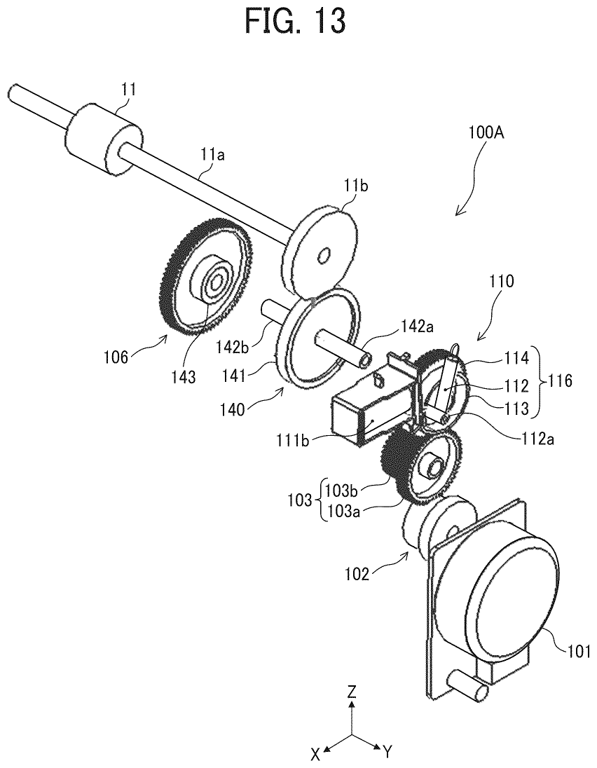

FIG. 13 is an exploded perspective view of an example of a drive device 100A using the roller type one-way clutch mechanism as the high-speed side one-way clutch mechanism and the low-speed side one-way clutch mechanism.

The drive device 100A illustrated in FIG. 13 includes an output member 140 to which a driving force is transmitted from the high-speed gear 116 and the low-speed gear 106. The output member 140 includes an output gear 141 that meshes with the roller gear 11b, a high-speed side support shaft 142a that supports the high-speed gear 116, and a low-speed side support shaft 142b that supports the low-speed gear 106.

The high-speed gear 116 is supported by the high-speed side support shaft 142a via the roller type one-way clutch mechanism, and the low-speed gear 106 is supported by the low-speed side support shaft 142b via the roller type one-way clutch mechanism.

When the mutilated gear 114 of the single rotation clutch mechanism 110 does not mesh with the high-speed side input gear 103a and the drive transmission is interrupted, the low-speed gear 106 relatively rotates in one direction with respect to the output member 140. Therefore, the roller type low-speed side one-way clutch mechanism 143 drivingly couples the low-speed gear 106 and the low-speed side support shaft 142b, and the output member 140 rotates together with the low-speed gear 106.

On the other hand, since the stopped high-speed gear 116 relatively rotates in the other direction with reference to the output member 140, the high-speed gear 116 relatively idles with respect to the high-speed side support shaft 142a, and the high-speed gear 116 does not rotate together with the output member 140.

When the mutilated gear 114 of the single rotation clutch mechanism 110 meshes with the high-speed side input gear 103a and drive transmission is performed, the high-speed gear 116 relatively rotates in one direction with reference to the output member 140. Therefore, the roller type high-speed side one-way clutch mechanism drivingly couples the high-speed gear 116 and the high-speed side support shaft 142a, and the output member 140 rotates together with the high-speed gear 116.

When the output member 140 rotates together with the high-speed gear 116, the low-speed gear 106 rotates in the other direction with reference to the output member 140. As a result, the low-speed gear 106 relatively idles with respect to the low-speed side support shaft 142b, and the low-speed gear 106 does not rotate together with the output member 140.

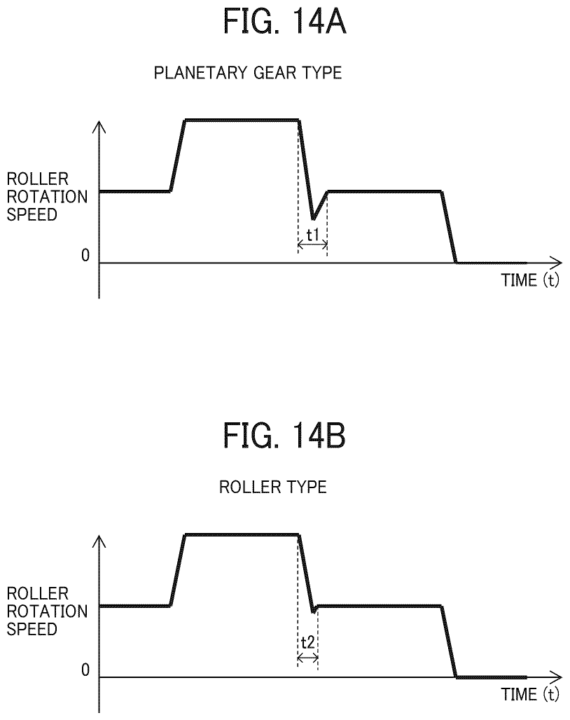

FIG. 14A is a graph of a change in the rotation speed of the sheet feed roller when the planetary gear type one-way clutch mechanism is provided in each of the drive transmission paths 210a and 210b.

FIG. 14B is a graph of a change in the rotation speed of the sheet feed roller in a case where the roller type one-way clutch mechanism is provided in each of the drive transmission paths 210a and 210b.

In general, the backlash (rotation angle from the idle state to the locked state) of the roller type one-way clutch is about 3 degrees, whereas the backlash (θ1 in FIGS. 7A and 7C) of the planetary gear type one-way clutch is about 13 degrees. Therefore, as illustrated in FIG. 14A, the time until the drive transmission path is switched from the high-speed drive transmission path 210a to the low-speed drive transmission path 210b is shorter in the roller type than in the planetary gear type (t2<t1). Thus, as compared with the planetary gear type, a decrease in the rotation speed of the sheet feed roller 11 and the pair of sheet ejection reverse rollers 57 at the time of switching the drive transmission path can be prevented, and the productivity can be enhanced. Furthermore, by enhancing the productivity, the travel distance of each unit can be suppressed, and the life of the image forming apparatus can be extended.

As compared with the planetary gear type, a decrease in the rotation speed of the roller at the time of switching the drive transmission path is suppressed, so that the positional accuracy of the sheet is enhanced. Thus, the sheet interval can be shortened while preventing the leading edge damage and the jam due to sheet rear-end collision, and the productivity can be enhanced. Since the sheet interval can be shortened, the sheet line speed can be reduced at a given productivity, and the rotation speed of the motor can be reduced. Accordingly, energy saving and noise reduction can be achieved. For example, in the case of a specification with a productivity of 60 [PPM] for a length of 210 [mm] of the sheet S, the sheet line speed needs to be 280 [mm/s] when the sheet interval is 70 [mm], but the sheet line speed can be reduced to 260 [mm/s] when the sheet interval is 50 [mm], and the sheet line speed can be reduced to 240 [mm/s] when the sheet interval is 30 [mm].

By the improvement of the positional accuracy of the sheet is improved, the sheet can enter the transfer nip T1 at a given timing in the sheet feeding drive device, and an image can be formed at a desired position of the sheet.

On the other hand, the roller type one-way clutch includes an outer ring, multiple micro rollers, a holder for holding multiple micro rollers, and multiple springs for biasing each of the multiple micro rollers, and has a large number of components, high manufacturing cost, and a high selling price. In contrast, the planetary gear type one-way clutch mechanism has an advantage that the configuration is simple and the drive device can be made inexpensive as compared with the roller type.

As the one-way clutch mechanism, a one-way clutch mechanism other than the planetary gear type and the roller type may be adopted. The type of the high-speed side one-way clutch mechanism and the type of the low-speed side one-way clutch mechanism may be different from each other. For example, the high-speed side one-way clutch mechanism may be a planetary gear type, and the low-speed side one-way clutch mechanism may be a roller type.

Without using the one-way clutch mechanism, the drive transmission path can be switched to be selected between the high-speed drive transmission path 210a and the low-speed drive transmission path 210b in conjunction with drive transmission/drive interruption of the single rotation clutch mechanism 110.

Descriptions are given of a drive device according to modifications of the above-described embodiments of the present disclosure.

### Modification 1

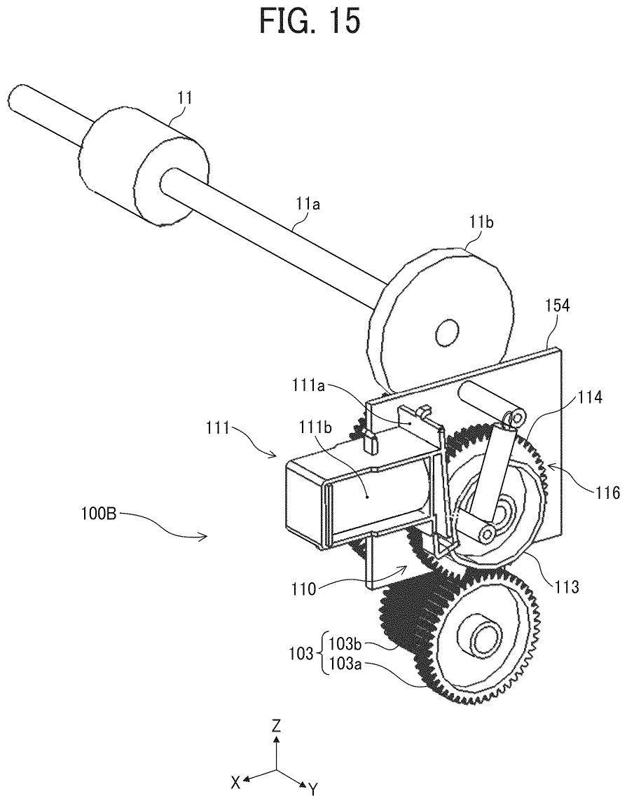

FIG. 15 is a perspective view of a drive device 100B of Modification 1 as viewed from one side in the axial direction (+Y direction).

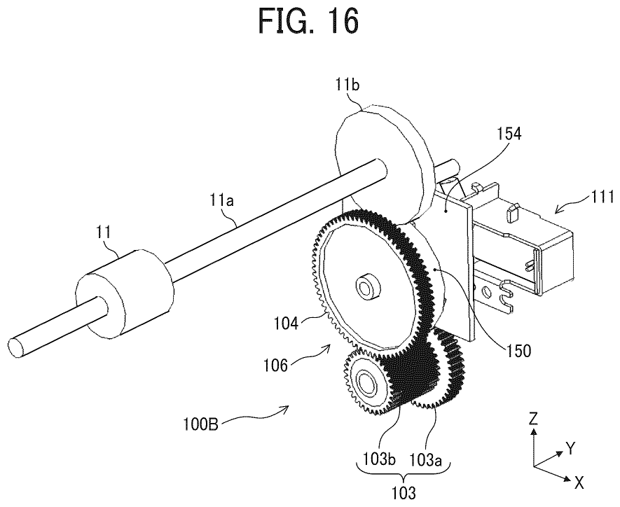

FIG. 16 is a perspective view of the drive device 100B of Modification 1 as viewed from the other side in the axial direction (−Y direction).

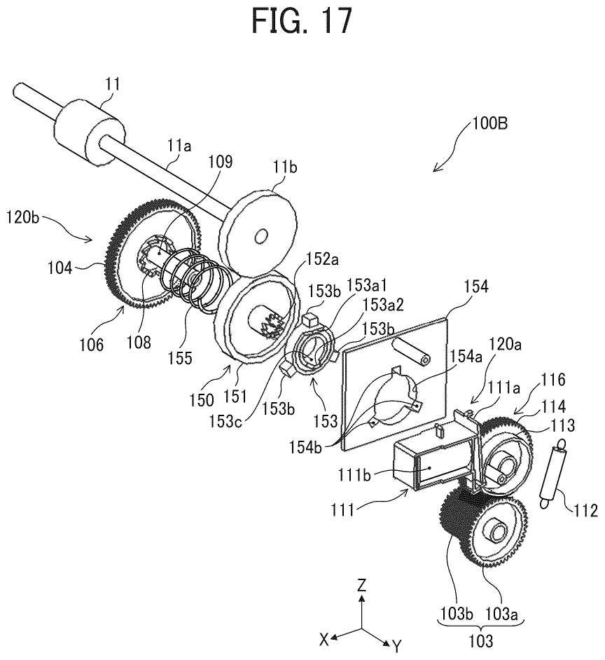

FIG. 17 is an exploded perspective view of the drive device 100B of Modification 1 as viewed from one side in the axial direction (+Y direction).

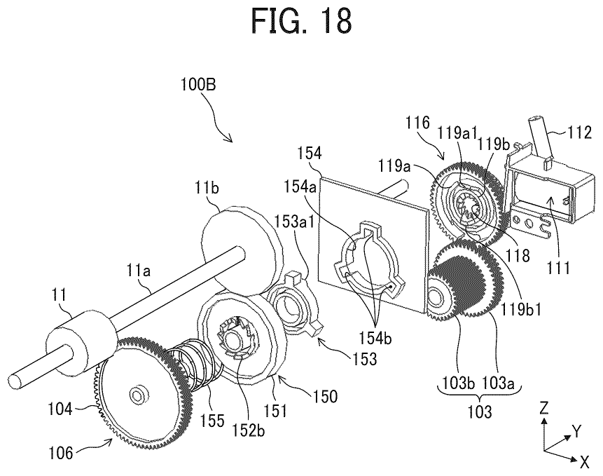

FIG. 18 is an exploded perspective view of the drive device 100B of Modification 1 as viewed from the other side in the axial direction (−Y direction).

The drive device 100B of Modification 1 includes a joint member 150 as a common output member to which the driving force is transmitted from the high-speed gear 116 and the low-speed gear 106. The joint member 150 includes an output gear 151 that meshes with the roller gear 11b. The joint member 150 includes a high-speed side input engagement portion 152a as a first drive coupling portion engaged with a high-speed side output engagement portion 118 provided in the high-speed gear 116 as a first output drive transmission member. The joint member 150 includes a low-speed side input engagement portion 152b as a second drive coupling portion engaged with the low-speed side output engagement portion 108 provided in the low-speed gear 106 as a second output drive transmission member.

Each of the engagement portions 108, 118, 152a, and 152b includes multiple protrusions protruding in the axial direction, and these protrusions are arranged along the circumferential direction. Each protrusion has a triangular shape when viewed from the radial direction.

The joint member 150 and the high-speed gear 116 are rotatably supported by a support shaft 109 provided in the low-speed gear 106. The joint member 150 is supported by the support shaft 109 so as to be movable in the axial direction between the high-speed gear 116 and the low-speed gear 106.

In the axial direction, a compression spring 155 as a thrust force generator is disposed between the joint member 150 and the low-speed gear 106 to urge the joint member 150 toward the high-speed gear 116.

The slide member 153 and the frame 154 are disposed between the joint member 150 and the high-speed gear 116 in the axial direction. An opposing face of the slide member 153 opposing the high-speed gear 116 is provided with a first cam follower portion 153a1 and a second cam follower portion 153a2 protruding toward the high-speed gear 116. The second cam follower portion 153a2 is provided at an interval of 180 degrees in the circumferential direction with respect to the first cam follower portion 153a1 inside the first cam follower portion 153a1 in the radial direction.

The slide member 153 is provided with three rotation stoppers 153b protruding in the radial direction at intervals of 120 degrees in the circumferential direction. The slide member 153 is provided with a through hole 153c through which the high-speed side output engagement portion 118 of the joint member 150 passes.

The frame 154 is provided with a holding hole 154a that holds the slide member 153 so as to be movable in the axial direction, and engagement holes 154b with which the rotation stoppers 153b of the slide member 153 are engaged. When the rotation stoppers 153b of the slide member 153 are engaged with the engagement holes 154b, the slide member 153 is held by the frame 154 in a non-rotatable manner.

An opposing face of the high-speed gear 116 opposing the slide member 153 includes a first switching cam portion 119a disposed radially outside and a second switching cam portion 119b disposed radially inside the first switching cam portion 119a. The first cam follower portion 153a1 of the slide member 153 abuts against the first switching cam portion 119a, and the second cam follower portion 153a2 of the slide member 153 abuts against the second switching cam portion 119b.

The first switching cam portion 119a is provided with a first protrusion 119a1 that protrudes in the axial direction and pushes the first cam follower portion 153a1 toward the low-speed gear 106. The second switching cam portion 119b is provided with a second protrusion 119b1 that protrudes in the axial direction and pushes the second cam follower portion 153a2 toward the low-speed gear 106. The second protrusion 119b1 is provided at an interval of 180 degrees in the circumferential direction with respect to the first protrusion 119a1.

In Modification 1, the slide member 153, the first switching cam portion 119a, and the second switching cam portion 119b constitute a pressing mechanism.

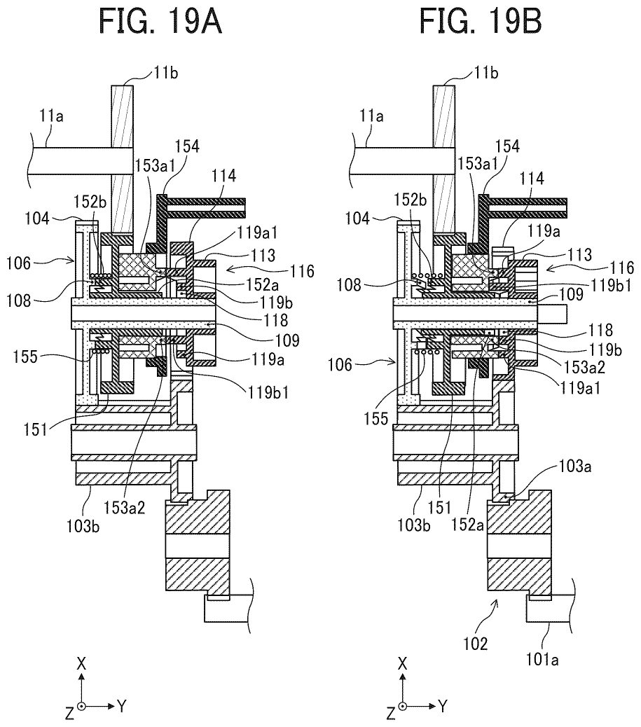

FIG. 19A is a cross-sectional view of the joint member 150 in a state where the joint member 150 is drivingly coupled to the low-speed gear 106.

FIG. 19B is a cross-sectional view of the joint member 150 in a state where the joint member 150 is drivingly coupled to the high-speed gear 116.

FIG. 19B illustrates a state in which the high-speed gear 116 rotates half a turn with respect to FIG. 19A.

As illustrated in FIG. 19A, when the toothless portion 114a of the mutilated gear 114 is located at the meshing position with the high-speed side input gear 103a, the first protrusion 119a1 of the first switching cam portion 119a abuts against the first cam follower portion 153a1 of the slide member 153, and pushes the slide member 153 toward the low-speed gear 106 against the biasing force of the compression spring 155. The second protrusion 119b1 of the second switching cam portion 119b abuts against the second cam follower portion 153a2 of the slide member 153, and pushes the slide member 153 toward the low-speed gear 106 against the biasing force of the compression spring 155.

The joint member 150 is pushed toward the low-speed gear 106 via the slide member 153 by the pushing of the protrusions 119a1 and 119b1. In the modification, the slide member 153 is pushed by the first protrusion 119a1 and the second protrusion 119b1 provided at an interval of 180 degrees in the circumferential direction with respect to the first protrusion 119a1. Thus, the slide member 153 and the joint member 150 can be pushed toward the low-speed gear 106 while preventing the attitude disturbance of the slide member 153 and the joint member 150.

When the joint member 150 is pushed toward the low-speed gear 106 in this manner, the low-speed side input engagement portion 152b of the joint member 150 is engaged with the low-speed side output engagement portion 108 of the low-speed gear 106, and the joint member 150 and the low-speed gear 106 are drivingly coupled. Specifically, the joint member 150 and the low-speed gear 106 are drivingly coupled by the protrusion of the low-speed side input engagement portion 152b entering between the protrusions of the low-speed side output engagement portion 108. Thus, the joint member 150 rotates integrally with the low-speed gear 106.

When the gear 114b of the mutilated gear 114 meshes with the high-speed side input gear 103a, the single rotation clutch mechanism 110 enters the drive transmission state, and the high-speed gear 116 is rotationally driven, the contact with the first protrusion 119a1 of the first cam follower portion 153a1 and the contact with the second protrusion 119b1 of the second cam follower portion 153a2 are released. Then, the first cam follower portion 153a1 goes down an inclined face following the first protrusion 119a1 of the first switching cam portion 119a by the biasing force of the compression spring 155 via the joint member 150 of the slide member 153. The second cam follower portion 153a2 goes down an inclined face following the second protrusion 119b1 of the second switching cam portion 119b. Thus, the joint member 150 moves toward the high-speed gear 116 by the biasing force of the compression spring 155, and the engagement between the low-speed side input engagement portion 152b and the low-speed side output engagement portion 108 is released.

As illustrated in FIG. 19B, the first cam follower portion 153a1 abuts against a plane perpendicular to the axial direction located closer to the mutilated gear 114 than the protrusion 119a1 of the first switching cam portion 119a. The second cam follower portion 153a2 abuts against a plane perpendicular to the axial direction located closer to the mutilated gear 114 than the protrusion 119b1 of the second switching cam portion 119b. Then, the high-speed side input engagement portion 152a of the joint member 150 is engaged with the high-speed side output engagement portion 118 of the high-speed gear 116, and the joint member 150 and the high-speed gear 116 are drivingly coupled. Specifically, a distal end protrusion of the high-speed side input engagement portion 152a enters between the protrusions of the high-speed side output engagement portion 118, so that the joint member 150 and the high-speed gear 116 are drivingly coupled. Thus, the joint member 150 rotates integrally with the high-speed gear 116.

As illustrated in FIG. 19B, in this modification, the first protrusion 119a1 of the first switching cam portion 119a and the second protrusion 119b1 of the second switching cam portion 119b are in contact with the opposing face of the slide member 153 opposing the high-speed gear 116. Thus, the attitude disturbance of the slide member 153 and the joint member 150 can be prevented or reduced when compared with a configuration in which the protrusions 119a1 and 119b1 are not in contact with the opposing face.

The slide member 153 is unrotatably held by the frame 154, and when the joint member 150 and the high-speed gear 116 are drivingly coupled and the joint member 150 and the high-speed gear 116 rotate integrally, the slide member 153 rotates relative to the high-speed gear 116.

Therefore, each cam follower portion 153a1, 153a2 of the slide member 153 moves in the circumferential direction on the switching cam portions 119a and 119b, and climbs on the inclined face continuing to the protrusions 119a1 and 119b1 before one rotation of the high-speed gear. Thus, the joint member 150 is pushed toward the low-speed gear 106 together with the slide member 153, and the engagement between the high-speed side input engagement portion 152a and the high-speed side output engagement portion 118 is released. Then, when the high-speed gear 116 makes one rotation and the drive transmission is interrupted by the single rotation clutch, each cam follower portions 153a1 and 153a2 abuts against the top face of the protrusions 119a1 and 119b1 of each switching cam portion again. Thus, as illustrated in FIG. 19A, the low-speed side input engagement portion 152b and the low-speed side output engagement portion 108 are engaged, and the low-speed gear 106 and the joint member 150 are drivingly coupled.

Also in this modification, the drive transmission path can be selectively switched between the high-speed drive transmission path 210a and the low-speed drive transmission path 210b in conjunction with the drive transmission/drive interruption of the single rotation clutch mechanism 110 without using electricity, and energy saving can be achieved.

In this modification, two switching cam portions and two cam follower portions are provided, but three or more switching cam portions and three or more cam follower portions may be provided, and the protrusions and the cam follower portions of the respective switching cam portions may be arranged at regular intervals in the circumferential direction. Thus, the slide member 153 abuts against the high-speed gear 116 at three or more points, and the attitude disturbance of the slide member 153 and the joint member 150 can be satisfactorily reduced during the movement in the axial direction.

In this modification, a thrust force toward the high-speed gear 116 is generated against the joint member 150 by the biasing force of the compression spring 155. However, the thrust force toward the high-speed gear 116 side may be generated against the joint member 150 by the following configuration. That is, the output gear 151 of the joint member 150 is configured as a helical gear that generates a thrust force on the high-speed gear 116 side. With such a configuration, when the high-speed gear 116 rotates, the slide member 153 and the joint member 150 are moved toward the high-speed gear 116 by the thrust force, and the high-speed side input engagement portion 152a and the high-speed side output engagement portion 118 can be engaged with each other. Thus, the number of components can be reduced, and the cost can be reduced.

In addition, by generating the thrust force toward the high-speed gear 116 against the joint member 150 with the helical teeth, a decrease in driving efficiency can be prevented when compared with the case of generating the thrust force toward the high-speed gear 116 against the joint member 150 with the compression spring 155.

In general, as the thrust force applied to the rotary body increases, the driving efficiency decreases. In addition, it is necessary to move the joint member 150 toward the high-speed gear against the frictional force generated between the tooth faces of the output gear 151 and the roller gear 11b according to the roller torque. When the thrust force is generated against the joint member 150 by the compression spring 155, it is necessary to set the biasing force (thrust force) of the compression spring 155 to be large so that the joint member 150 can move toward the high-speed gear 116 even with the maximum torque. On the other hand, in the configuration in which the output gear 151 has helical teeth and the helical teeth generate the thrust force against the joint member 150, the thrust force changes according to the roller torque similarly to the frictional force between the tooth faces, so that the excessive thrust force is not generated, different from the compression spring 155. As a result, when compared with the compression spring 155, the thrust force applied to the joint member 150 can be suppressed, and a decrease in driving efficiency can be prevented.

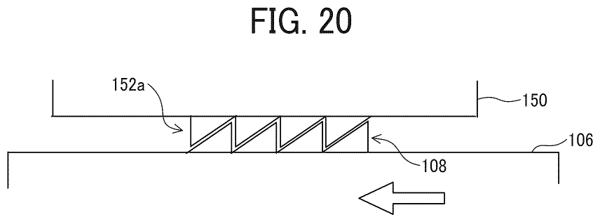

In addition, each of the protrusions of the low-speed side input engagement portion 152b and each of the protrusions of the low-speed side output engagement portion 108 may have a shape as illustrated in FIG. 20, and a thrust force toward the high-speed gear 116 may be generated against the joint member 150. Specifically, as illustrated in FIG. 20, each protrusion of low-speed side input engagement portion 152b is formed of a flat portion perpendicular to the circumferential direction and an inclined face whose height decreases toward the upstream side in the rotation direction of the low-speed gear 106, and has a right triangular shape when viewed from the radial direction. Each of the protrusions of the low-speed side output engagement portion 108 is formed of a flat portion perpendicular to the circumferential direction and an inclined face whose height decreases toward the downstream side in the rotation direction of the low-speed gear 106, and has a right triangular shape when viewed from the radial direction.

Each protrusion of the low-speed side input engagement portion 152b of the joint member 150 is pushed toward the high-speed gear by the inclined face of each protrusion of the low-speed side output engagement portion 108 of the low-speed gear 106. When the high-speed gear 116 rotates and the pushing toward the low-speed gear 106 is released, the thrust force toward the high-speed gear 116 is generated in the joint member 150 by the pushing by the inclined faces of the protrusions of the low-speed side output engagement portion 108. Thus, when the high-speed gear 116 rotates, the slide member 153 and the joint member 150 are moved toward the high-speed gear 116 by the thrust force, and the high-speed side input engagement portion 152a and the high-speed side output engagement portion 118 can be engaged with each other.

Even with the configuration illustrated in FIG. 20, the compression spring 155 can be eliminated, the number of components can be reduced, and cost can be reduced. The pushing force (thrust force) by the inclined face of each protrusion of the low-speed side output engagement portion 108 illustrated in FIG. 20 changes according to the roller torque. Therefore, even with the configuration illustrated in FIG. 20, the thrust force applied to the joint member 150 can be suppressed as compared with the case where the compression spring 155 is used, and the decrease in the driving efficiency can be suppressed.

Each of the protrusions of the low-speed side input engagement portion 152b and each of the protrusions of the low-speed side output engagement portion 108 may have an isosceles triangle shape when viewed from the radial direction, or may have a configuration in which one of the protrusions of the low-speed side input engagement portion 152b and the low-speed side output engagement portion 108 has an inclined face.

The output gear 151 of the joint member 150 may be teeth that generate a thrust force on the high-speed gear 116 side, and the protrusions of the low-speed side input engagement portion 152b and the protrusions of the low-speed side output engagement portion 108 may have shapes as illustrated in FIG. 20.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

In the above description, an example in which the present disclosure is applied to the drive device that drives the sheet feed roller 11 of the image forming apparatus 1 and the drive device that drives the pair of sheet ejection reverse rollers 57 has been described, but the present disclosure is not limited thereto. For example, the present disclosure can also be applied to a drive device that drives a sheet ejection roller of a post-processing apparatus, a drive device that drives a sheet feed roller of an ADF, a drive device that drives a sheet ejection roller, and a drive device that drives a sheet feed roller of a mass sheet feeding apparatus optionally set in the image forming apparatus 1. The present disclosure can be applied not only to the sheet feed roller and the sheet ejection roller, but also to a drive device that drives, for example, a conveyance roller that conveys a sheet in an image forming apparatus, a post-processing apparatus, and an automatic document feeder (ADF).

The single rotation clutch mechanism may be configured such that multiple toothless portions of the mutilated gear 114 and multiple stepped portions of the cam are provided in the circumferential direction, and the drive transmission is interrupted when the high-speed gear 116 (mutilated gear 114) rotates by a given rotation angle.

The embodiments described above are just examples, and the various aspects of the present disclosure attain respective effects as follows.

### Aspect 1

In Aspect 1, in a drive transmission device that selectively switches the drive transmission path between a first drive transmission path such as the high-speed drive transmission path 210a for rotating an output target rotary body such as the sheet feed roller 11 at a first speed and a second drive transmission path such as the low-speed drive transmission path 210b for rotating the output target rotary body at the second speed lower than the first speed, a single rotation clutch mechanism 110 is provided in the first drive transmission path.

The single rotation clutch mechanism generally includes a drive transmission member (in the present embodiment, the mutilated gear 114) of the single rotation clutch mechanism, a restricting member (in the present embodiment, the flapper 111a) that is engaged with an engagement portion (in the present embodiment, the stepped portion 113a of the cam 113) that rotates integrally with the drive transmission member to restrict the rotation of the drive transmission member, and an actuator (in the present embodiment, the solenoid 111b) that releases the rotation restriction of the restricting member. When the actuator is turned on to release the rotation restriction of the restricting member, the drive transmission member rotates to enter the drive transmission state. When the drive transmission member starts to rotate and the engagement portion moves from the engagement position with the restricting member, the actuator is turned off.

Then, when the drive transmission member of the single rotation clutch mechanism rotates by a given rotation angle (in the present embodiment, one rotation) and the engagement portion reaches the engagement position, the restricting member is engaged with the engagement portion, and the rotation of the drive transmission member is restricted to cut off the drive transmission. As described above, the single rotation clutch mechanism turns on the actuator only when the rotation restriction of the restricting member is released, and even if the actuator is turned off after the release of the rotation restriction, the drive transmission is performed during the period in which the drive transmission member rotates by the given rotation angle.

For example, by appropriately adjusting the rotation speed of the drive source and the reduction ratio from the drive source to the single rotation clutch mechanism, a drive transmission period of the single rotation clutch mechanism (period in which the drive transmission member of the single rotation clutch mechanism rotates by a given rotation angle) can be matched with the period in which the output target rotary body needs to be rotationally driven at the first speed.

Therefore, by using the single rotation clutch mechanism, electric power can be consumed only when the rotation restriction of the restricting member is released, and as compared a typical drive transmission device in which the electromagnetic clutch is provided in the first drive transmission path, electric power consumption at the time of drive transmission to the output target rotary body in the first drive transmission path can be suppressed, and energy saving can be achieved.

### Aspect 2

In Aspect 2, in the drive transmission device according to Aspect 1, the single rotation clutch mechanism 110 includes the mutilated gear 114, a restricting member such as the flapper 111a that restricts rotation of the mutilated gear 114 by engaging with an engagement portion such as a stepped portion 113a that rotates integrally with the mutilated gear 114 in a state where the toothless portion 114a of the mutilated gear 114 is located at a meshing position with the input gear 103 that meshes with the mutilated gear 114, and an actuator such as the solenoid 111b that drives the restricting member to release engagement of the restricting member with the engagement portion.

With this configuration, when the rotation of the mutilated gear 114 is restricted, the mutilated gear 114 and the input gear 103 do not mesh with each other, the driving force is not transmitted to the mutilated gear 114, and drive transmission is interrupted. When the restriction on the rotation of the mutilated gear 114 is released, the mutilated gear 114 and the input gear 103 mesh with each other, and the driving force is transmitted from the input gear 103 to the mutilated gear 114. The actuator is driven only when the engagement with the engagement portion of the restricting member is released, and thereafter, the drive transmission is performed even when the actuator is turned off. Thus, power consumption can be reduced and energy saving can be achieved as compared with the typical drive transmission device in which the electromagnetic clutch is provided in the first drive path.

The cost can be reduced as compared with the other single rotation clutch mechanism 110.

### Aspect 3

In Aspect 3, in the drive transmission device according to Aspect 1 or 2, drive transmission of the second drive transmission path such as the low-speed drive transmission path 210b is interrupted during drive transmission of the single rotation clutch mechanism 110, and a driving force of a drive source such as the sheet feeding motor 101 is transmitted to the output target rotary body such as the sheet feed roller 11 via the second drive transmission path during drive transmission interruption of the single rotation clutch mechanism 110.

With this configuration, the drive transmission path can be selectively switched between the first drive transmission path such as the high-speed drive transmission path 210a and the second drive transmission path such as the low-speed drive transmission path 210b in conjunction with the drive transmission/drive transmission interruption of the single rotation clutch mechanism 110.

### Aspect 4

In Aspect 4, in the drive transmission device according to Aspect 3, a one-way clutch is provided in the first drive transmission path such as the high-speed drive transmission path 210a and the second drive transmission path such as the low-speed drive transmission path 210b.

With this configuration, as described in the embodiment, when the single rotation clutch mechanism 110 interrupts the drive transmission, the drive transmission member of the second drive transmission path such as the low-speed gear 106 relatively rotates in one direction with respect to the output member. Thus, the one-way clutch of the second drive transmission path is drivingly coupled to the output member, and the driving force is transmitted to the output member via the second drive transmission path. At this time, since the drive transmission member of the first drive transmission path such as the stopped high-speed gear 116 rotates in the other direction with reference to the output member, the one-way clutch of the first drive transmission path is not drivingly coupled to the output member, and the rotation of the output member is not restricted by the single rotation clutch mechanism and the output member rotates.

On the other hand, when the single rotation clutch is performing the drive transmission, the drive transmission member of the first drive transmission path rotates in one direction relative to the output member. Thus, the one-way clutch of the first drive transmission path is drivingly coupled to the output member, and the driving force is transmitted to the output member via the first drive transmission path. Since the rotation speed of the output member when the driving force is transmitted via the first drive transmission path is faster than the rotation speed of the drive transmission member of the second drive transmission path, the drive transmission member of the second drive transmission path relatively rotates in the other direction with respect to the output member. Thus, the one-way clutch of the second drive transmission path is not drivingly coupled to the output member, and the drive transmission of the second drive transmission path is interrupted.

Thus, the drive transmission of the second drive transmission path can be interrupted during the drive transmission of the clutch mechanism, and the driving force can be transmitted to the output target rotary body via the second drive transmission path during the drive transmission interruption of the clutch mechanism.

The drive transmission path can be selectively switched between the first drive transmission path and the second drive transmission path without using electricity, and energy saving can be achieved.

### Aspect 5

In Aspect 5, in the drive transmission device according to Aspect 4, at least one of the one-way clutch of the first drive transmission path such as the high-speed drive transmission path 210a and the one-way clutch of the second drive transmission path such as the low-speed drive transmission path 210b is a planetary gear type one-way clutch.

With this configuration, as described in the embodiment, the configuration is simple as compared with the roller type one-way clutch mechanism, and the device can be made inexpensive as compared with the roller type.

### Aspect 6

In Aspect 6, in the drive transmission device according to Aspect 4, at least one of the one-way clutch of the first drive transmission path or the one-way clutch of the second drive transmission path is a roller type one-way clutch.

With this configuration, as described in the embodiment, the time during which the drive transmission path is switched is short, and a decrease in the rotation speed of the output target rotary body such as the sheet feed roller 11 at the time of switching the drive transmission path can be suppressed.

### Aspect 7

In Aspect 7, the drive transmission device according to Aspect 3 further includes a common output member such as the joint member 150 that includes a first drive coupling portion such as the high-speed side input engagement portion 152a drivingly coupled to a first drive output transmission member such as the high-speed gear 116 of the first drive transmission path such as the high-speed drive transmission path 210a and a second drive coupling portion such as the low-speed side input engagement portion 152b drivingly coupled to a second output drive transmission member such as the low-speed gear 106 of the second drive transmission path such as the low-speed drive transmission path 210b disposed coaxially with the first output drive transmission member, the common output member being disposed between the first output drive transmission member and the second output drive transmission member, and held movably in an axial direction, in which when drive of the single rotation clutch mechanism 110 is interrupted, the common output member is pushed toward the second output drive transmission member to drivingly couple the second drive coupling portion to the second output drive transmission member, and when drive of the single rotation clutch mechanism 110 is transmitted, the common output member is pushed toward the first output drive transmission member to drivingly couple the first drive coupling portion to the first output drive transmission member.

With this configuration, as described in the modification, the drive transmission path can be selectively switched between the first drive transmission path and the second drive transmission path without using electricity, and energy saving can be achieved.

### Aspect 8

In Aspect 8, the drive transmission device according to Aspect 7 includes a thrust generator (e.g., the compression spring 155) that generates a thrust force toward the first output drive transmission member such as the high-speed gear 116 against the common output member such as the joint member 150, and a pressing mechanism (slide member 153, first switching cam portion 119a, and second switching cam portion 119b) that pushes the common output member toward the second output drive transmission member such as the low-speed gear 106 to drivingly couple the second drive coupling portion such as the low-speed side input engagement portion 152b to the second output drive transmission member when drive of the single rotation clutch mechanism 110 is interrupted, and releases the push against the common output member when drive of the single rotation clutch mechanism 110 is transmitted.

With this configuration, as described in Modification 1, when drive of the single rotation clutch mechanism 110 is interrupted, the common output member such as the joint member 150 is pushed toward the second output drive transmission member side such as the low-speed gear 106 by the pressing mechanism, and the second drive coupling portion such as the low-speed side input engagement portion 152b can be drivingly coupled to the second output drive transmission member.

Upon release of push of the common output member by the pressing mechanism when drive of the single rotation clutch mechanism 110 is transmitted, the common output member is moved toward the first output drive transmission member such as the high-speed gear 116 by the thrust force generated by a thrust force generator such as the compression spring 155, and the first drive coupling portion such as the high-speed side input engagement portion 152a can be drivingly coupled to the first output drive transmission member.

### Aspect 9

In Aspect 9, in the drive transmission device according to Aspect 8, in the second drive coupling portion such as the low-speed side input engagement portion 152b, multiple protrusions protruding in the axial direction from an opposing face of the common output member such as the joint member 150 opposing the second output drive transmission member such as the low-speed gear 106 are arranged side by side in a circumferential direction, and in the second output drive transmission member, multiple protrusions protruding in the axial direction from a face opposing the common output member, entering between the protrusions of the second drive coupling portion, and engaging with the protrusions of the second drive coupling portion is arranged side by side in the circumferential direction, and the thrust generator that generates the thrust force is an inclined face provided on at least one of each protrusion of the second drive coupling portion and each protrusion of the second output drive transmission member.

With this configuration, as described with reference to FIG. 20, the multiple protrusions of the low-speed gear 106 pushes the protrusions of the second drive coupling portion such as the low-speed side input engagement portion 152b toward the first output drive transmission member such as the high-speed gear 116, and a thrust force toward the first output drive transmission member can be generated with respect to the common output member such as the joint member 150.

In addition, since the thrust force changes according to the roller torque similarly to the frictional force between the tooth faces of the output gear and the roller gear of the common output member, the thrust force applied to the joint member 150 can be suppressed as compared with the case of using the compression spring 155, and a decrease in driving efficiency can be suppressed.

### Aspect 10

In Aspect 10, in the drive transmission device according to Aspect 8 or 9, the thrust generator that generates the thrust force is the helical shaped output gear 151 of the common output member such as the joint member 150.

With this configuration, the thrust force toward the first output drive transmission member can be generated against the common output member such as the joint member 150 by the helical teeth of the output gear 151. Since the thrust force generated by the helical teeth changes according to the roller torque similarly to the frictional force between the tooth faces of the output gear 151 and the roller gear, the thrust force applied to the joint member 150 can be suppressed as compared with the case of using the compression spring 155, and the decrease in the driving efficiency can be suppressed.

### Aspect 11

In Aspect 11, a sheet conveyor includes a conveyance roller (in the present embodiment, the sheet feed roller 11 and the sheet ejection reverse roller) that conveys a sheet; a drive source (in the present embodiment, the sheet feeding motor 101 and the sheet ejection motor 401) that drives the conveyance roller, and a drive transmission device such as the drive transmission unit 200 that transmits a driving force of the drive source to the conveyance roller, a rotation speed of the conveyance roller being changed according to a position of the sheet being conveyed, the drive transmission device according to any one of Aspects 1 to 10 being used as the drive transmission device.

With this configuration, productivity can be enhanced, and energy saving can be achieved. The rotation speed of the conveyance roller can be changed without changing the rotation speed of the drive source.

### Aspect 12

In Aspect 12, in the sheet conveyor according to Aspect 11, the conveyance roller is the sheet feed roller 11 or a sheet ejection reverse roller.

With this configuration, the sheet feeding time can be shortened, the sheet ejection time can be shortened, and the switchback conveying can be shortened.

### Aspect 13

In Aspect 13, an image forming apparatus that forms an image on a sheet conveyed by a sheet conveyor uses the sheet conveyor according to Aspect 11 or 12 as the sheet conveyor.

With this configuration, productivity can be enhanced, and energy saving can be achieved.

### Aspect 14

In Aspect 14, a drive transmission device includes a transmission to transmit a driving force from a drive source to a rotator via a transmission path. The transmission path includes a first drive transmission path and a second drive transmission path. The first drive transmission path includes a single-rotation clutch to rotate a rotator at a first speed. The second drive transmission path rotates the rotator at a second speed lower than the first speed. The single-rotation clutch of the first drive transmission path selectively switches the transmission path between the first drive transmission path and the second drive transmission path.

### Aspect 15

In Aspect 15, in the drive transmission device according to Aspect 15, the transmission transmits the driving force from the drive source to the rotator via an input gear. The single-rotation clutch includes a cam, a mutilated gear, a restricting member, and an actuator. The cam has an engagement portion. The mutilated gear has a toothless portion. The mutilated gear meshes with the input gear at a meshing position and rotating integrally with the engagement portion of the cam. The restricting member restricts a rotation of the mutilated gear. The restricting member is engageable with the engagement portion when the toothless portion is at the meshing position. The actuator drives the restricting member to disengage the restricting member from the engagement portion.

### Aspect 16

In Aspect 16, in the drive transmission device according to Aspect 14 or 15, the single-rotation clutch transmits the driving force from the drive source to the rotator via the first drive transmission path while interrupting a transmission of the driving force in the second drive transmission path, and interrupts the transmission of the driving force from the drive source to the rotator via the first drive transmission path while transmitting the driving force via the second drive transmission path.

### Aspect 17

In Aspect 17, in the drive transmission device according to Aspect 16, the first drive transmission path includes a first one-way clutch, and the second drive transmission path includes a second one-way clutch.

### Aspect 18

In Aspect 18, in the drive transmission device according to Aspect 17, at least one of the first one-way clutch of the first drive transmission path or the second one-way clutch of the second drive transmission path includes a planetary gear type one-way clutch.

### Aspect 19

In Aspect 19, in the drive transmission device according to Aspect 17, at least one of the one-way clutch of the first drive transmission path or the one-way clutch of the second drive transmission path includes a roller type one-way clutch.

### Aspect 20

In Aspect 20, the drive transmission device according to Aspect 16 further includes a common output member including a first drive coupling portion and a second drive coupling portion. The first drive coupling portion is drivingly coupled to a first output drive transmission member of the first drive transmission path. The second drive coupling portion is drivingly coupled to a second output drive transmission member of the second drive transmission path disposed coaxially with the first output drive transmission member. The common output member is disposed between the first output drive transmission member and the second output drive transmission member, and is held movably in an axial direction. The common output member is thrust moved toward the second output drive transmission member to drivingly couple the second drive coupling portion to the second output drive transmission member, when a driving of the single-rotation clutch is interrupted. The common output member is thrust moved toward the first output drive transmission member to drivingly couple the first drive coupling portion to the first output drive transmission member, when the driving of the single-rotation clutch is transmitted.

### Aspect 21

In Aspect 21, the drive transmission device according to Aspect 20 further includes a thrust generator, and a pressing mechanism. The thrust generator generates a thrust force toward the first output drive transmission member against the common output member. The pressing mechanism presses the common output member toward the second output drive transmission member to drivingly couple the second drive coupling portion to the second output drive transmission member, when drive of the single-rotation clutch is interrupted, and releases the pressing against the common output member, when drive of the single-rotation clutch is transmitted.

### Aspect 22

In Aspect 22, in the drive transmission device according to Aspect 21, the second drive coupling portion includes multiple protrusions protruding in the axial direction from an opposing face of the common output member facing the second output drive transmission member and being arranged side by side in a circumferential direction. The second output drive transmission member includes multiple protrusions protruding in the axial direction from an opposing face of the second output drive transmission member facing the common output member, entering between the multiple protrusions of the second drive coupling portion, engaging with the multiple protrusions of the second drive coupling portion, and being arranged side by side in the circumferential direction. The thrust generator that generates the thrust force has an inclined face provided on at least one of each protrusion of the second drive coupling portion and each protrusion of the second output drive transmission member.

### Aspect 23

In Aspect 23, in the drive transmission device according to Aspect 21 or 22, the thrust generator that generates the thrust force is a helical gear of the common output member.

### Aspect 24

In Aspect 24, a sheet conveyor includes a conveyance roller, a drive source, and the drive transmission device according to any one of Aspects 14 to 23. The conveyance roller conveys a sheet. The drive source drives the conveyance roller. The drive transmission device transmits a driving force of the drive source to the conveyance roller, and changes a rotation speed of the conveyance roller according to a position of the sheet being conveyed.

### Aspect 25

In Aspect 25, in the sheet conveyor according to Aspect 24, the conveyance roller is a sheet feed roller.

### Aspect 26

In Aspect 26, in the sheet conveyor according to Aspect 24, the conveyance roller is a sheet ejection reverse roller.

### Aspect 27

In Aspect 27, an image forming apparatus including the sheet conveyor according to any one of Aspects 24 to 26 to convey the sheet to form an image on the sheet.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A drive transmission device comprising:
a transmission to transmit a driving force from a drive source to a rotator via a transmission path,
the transmission path including:
a first drive transmission path including a single-rotation clutch to rotate a rotator at a first speed; and
a second drive transmission path to rotate the rotator at a second speed lower than the first speed,
wherein the single-rotation clutch of the first drive transmission path selectively switches the transmission path between the first drive transmission path and the second drive transmission path.

2. The drive transmission device according to claim 1,
wherein the transmission transmits the driving force from the drive source to the rotator via an input gear,
the single-rotation clutch includes:
a cam having an engagement portion,
a mutilated gear having a toothless portion,
the mutilated gear meshing with the input gear at a meshing position and rotating integrally with the engagement portion of the cam;
a restricting member to restrict a rotation of the mutilated gear,
the restricting member engageable with the engagement portion when the toothless portion is at the meshing position; and
an actuator to drive the restricting member to disengage the restricting member from the engagement portion.

3. The drive transmission device according to claim 1,
wherein the single-rotation clutch:
transmits the driving force from the drive source to the rotator via the first drive transmission path while interrupting a transmission of the driving force in the second drive transmission path; and
interrupts the transmission of the driving force from the drive source to the rotator via the first drive transmission path while transmitting the driving force via the second drive transmission path.

4. The drive transmission device according to claim 3,
wherein the first drive transmission path includes a first one-way clutch, and
the second drive transmission path includes a second one-way clutch.

5. The drive transmission device according to claim 4,
wherein at least one of the first one-way clutch of the first drive transmission path or the second one-way clutch of the second drive transmission path includes a planetary gear type one-way clutch.

6. The drive transmission device according to claim 4,
wherein at least one of the one-way clutch of the first drive transmission path or the one-way clutch of the second drive transmission path includes a roller type one-way clutch.

7. The drive transmission device according to claim 3, further comprising:
a common output member including:
a first drive coupling portion drivingly coupled to a first output drive transmission member of the first drive transmission path; and
a second drive coupling portion drivingly coupled to a second output drive transmission member of the second drive transmission path disposed coaxially with the first output drive transmission member,
the common output member:
being disposed between the first output drive transmission member and the second output drive transmission member; and
being held movably in an axial direction,
wherein the common output member is thrust moved toward the second output drive transmission member to drivingly couple the second drive coupling portion to the second output drive transmission member, when a driving of the single-rotation clutch is interrupted, and
the common output member is thrust moved toward the first output drive transmission member to drivingly couple the first drive coupling portion to the first output drive transmission member, when the driving of the single-rotation clutch is transmitted.

8. The drive transmission device according to claim 7, further comprising:
a thrust generator to generate a thrust force toward the first output drive transmission member against the common output member; and
a pressing mechanism to:
press the common output member toward the second output drive transmission member to drivingly couple the second drive coupling portion to the second output drive transmission member, when drive of the single-rotation clutch is interrupted; and
release the pressing against the common output member, when drive of the single-rotation clutch is transmitted.

9. The drive transmission device according to claim 8,
wherein the second drive coupling portion includes multiple protrusions:
protruding in the axial direction from an opposing face of the common output member facing the second output drive transmission member, and
being arranged side by side in a circumferential direction, and
the second output drive transmission member includes multiple protrusions:
protruding in the axial direction from an opposing face of the second output drive transmission member facing the common output member;
entering between the multiple protrusions of the second drive coupling portion;
engaging with the multiple protrusions of the second drive coupling portion; and
being arranged side by side in the circumferential direction, and
the thrust generator that generates the thrust force has an inclined face provided on at least one of each protrusion of the second drive coupling portion and each protrusion of the second output drive transmission member.

10. The drive transmission device according to claim 8,
wherein the thrust generator that generates the thrust force is a helical gear of the common output member.

11. A sheet conveyor comprising:
a conveyance roller to convey a sheet;
a drive source to drive the conveyance roller; and
the drive transmission device according to claim 1 to:
transmit a driving force of the drive source to the conveyance roller; and
change a rotation speed of the conveyance roller according to a position of the sheet being conveyed.

12. The sheet conveyor according to claim 11,
wherein the conveyance roller is a sheet feed roller.

13. The sheet conveyor according to claim 11,
wherein the conveyance roller is a sheet ejection reverse roller.

14. An image forming apparatus comprising:
the sheet conveyor according to claim 11 to convey the sheet to form an image on the sheet.
